(19) United States
(12) Patent Application Publication
(10) Pub. No.: US 2026/0052473 A1
(43) Pub. Date: Feb. 19, 2026

(54) MEASUREMENT GAP DEACTIVATION TIMING

(71) Applicant: QUALCOMM Incorporated, San Diego, CA (US)

(72) Inventors: Diana MAAMARI, San Diego, CA (US); Huilin XU, Temecula, CA (US); Kazuki TAKEDA, Minato-ku (JP)

(21) Appl. No.: 18/803,371

(22) Filed: Aug. 13, 2024

(51) Int. Cl. H04W 52/02; H04W 24/10; H04W 76/28

(52) U.S. Cl. CPC H04W 52/0235; H04W 24/10; H04W 76/28

(57) ABSTRACT

Methods, systems, and devices for wireless communications are described. A user equipment (UE) may receive control signaling indicating on durations. The UE may receive, during a first monitoring occasion (MO), a wake-up signal (WUS) indicating for the UE to monitor during an on duration overlapping with a measurement gap; the UE may monitor for a measurement gap deactivation notification in a second MO, where an offset between the second MO and the measurement gap may satisfy a threshold. The UE may receive a deactivation notification in a first MO for a measurement gap overlapping with a second MO, where an offset between the deactivation notification and the measurement gap may satisfy a threshold; the UE may monitor for a WUS in the second MO, where a second offset between the second MO and an on duration may satisfy a second threshold. The UE may refrain from performing a monitoring procedure.

### FIELD OF TECHNOLOGY

The following relates to wireless communications, including measurement gap deactivation timing.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling indicating a set of multiple on durations and a set of multiple off durations of a discontinuous reception (DRX) cycle, receiving a deactivation notification during a first monitoring occasion (MO) during a first on duration of the set of multiple on durations, where the deactivation notification indicates to deactivate a measurement gap based on the measurement gap overlapping with a second MO, and where a first time offset between reception of the deactivation notification and the measurement gap satisfies a threshold measurement gap offset value, and monitoring, based on the first time offset satisfying the threshold measurement gap offset value and deactivating the measurement gap according to the deactivation notification, for a wake-up signal (WUS) in the second MO, the WUS indicating for the UE to wake up during a second on duration of the set of multiple on durations, where a second time offset between the second MO and a second on duration of the set of multiple on durations satisfies a threshold time gap value.

A UE for wireless communications is described. The UE may include one or more memories storing processor executable code, and one or more processors coupled with the one or more memories. The one or more processors may individually or collectively be operable to execute the code to cause the UE to receive control signaling indicating a set of multiple on durations and a set of multiple off durations of a DRX cycle, receive a deactivation notification during a first MO during a first on duration of the set of multiple on durations, where the deactivation notification indicates to deactivate a measurement gap based on the measurement gap overlapping with a second MO, and where a first time offset between reception of the deactivation notification and the measurement gap satisfies a threshold measurement gap offset value, and monitor, based on the first time offset satisfying the threshold measurement gap offset value and deactivating the measurement gap according to the deactivation notification, for a WUS in the second MO, the WUS indicating for the UE to wake up during a second on duration of the set of multiple on durations, where a second time offset between the second MO and a second on duration of the set of multiple on durations satisfies a threshold time gap value.

Another UE for wireless communications is described. The UE may include means for receiving control signaling indicating a set of multiple on durations and a set of multiple off durations of a DRX cycle, means for receiving a deactivation notification during a first MO during a first on duration of the set of multiple on durations, where the deactivation notification indicates to deactivate a measurement gap based on the measurement gap overlapping with a second MO, and where a first time offset between reception of the deactivation notification and the measurement gap satisfies a threshold measurement gap offset value, and means for monitoring, based on the first time offset satisfying the threshold measurement gap offset value and deactivating the measurement gap according to the deactivation notification, for a WUS in the second MO, the WUS indicating for the UE to wake up during a second on duration of the set of multiple on durations, where a second time offset between the second MO and a second on duration of the set of multiple on durations satisfies a threshold time gap value.

A non-transitory computer-readable medium storing code for wireless communications is described. The code may include instructions executable by one or more processors to receive control signaling indicating a set of multiple on durations and a set of multiple off durations of a DRX cycle, receive a deactivation notification during a first MO during a first on duration of the set of multiple on durations, where the deactivation notification indicates to deactivate a measurement gap based on the measurement gap overlapping with a second MO, and where a first time offset between reception of the deactivation notification and the measurement gap satisfies a threshold measurement gap offset value, and monitor, based on the first time offset satisfying the threshold measurement gap offset value and deactivating the measurement gap according to the deactivation notification, for a WUS in the second MO, the WUS indicating for the UE to wake up during a second on duration of the set of multiple on durations, where a second time offset between the second MO and a second on duration of the set of multiple on durations satisfies a threshold time gap value.

Some examples of the method, UEs, and non-transitory computer-readable medium described herein may further include operations, features, means, or instructions for receiving the WUS in the second MO in accordance with monitoring for the WUS and monitoring during the second on duration based on receiving the WUS.

Some examples of the method, UEs, and non-transitory computer-readable medium described herein may further include operations, features, means, or instructions for refraining from performing one or more measurements associated with neighboring cells in the measurement gap based on deactivating the measurement gap.

In some examples of the method, UEs, and non-transitory computer-readable medium described herein, the WUS includes a low-power wake-up signal (LP-WUS) or a downlink control information (DCI) signal.

In some examples of the method, UEs, and non-transitory computer-readable medium described herein, the threshold measurement gap offset value may be associated with an amount of time for the UE to tune to a frequency at which to perform one or more measurements during the measurement gap.

A method for wireless communications by a UE is described. The method may include receiving control signaling indicating a set of multiple on durations and a set of multiple off durations associated with a DRX cycle, receiving a WUS during a first MO, the WUS indicating for the UE to monitor during an on duration of the set of multiple on durations, where the on duration at least partially overlaps with a measurement gap, and monitoring, during the on duration based on the WUS, for a deactivation notification in a second MO during the on duration, where the monitoring is based on the on duration at least partially overlapping with the measurement gap, where the deactivation notification indicates to deactivate the measurement gap, and where a time offset between the second MO and the measurement gap satisfy a threshold measurement gap offset value.

A UE for wireless communications is described. The UE may include one or more memories storing processor executable code, and one or more processors coupled with the one or more memories. The one or more processors may individually or collectively be operable to execute the code to cause the UE to receive control signaling indicating a set of multiple on durations and a set of multiple off durations associated with a DRX cycle, receive a WUS during a first MO, the WUS indicating for the UE to monitor during an on duration of the set of multiple on durations, where the on duration at least partially overlaps with a measurement gap, and monitor, during the on duration based on the WUS, for a deactivation notification in a second MO during the on duration, where the monitoring is based on the on duration at least partially overlapping with the measurement gap, where the deactivation notification indicates to deactivate the measurement gap, and where a time offset between the second MO and the measurement gap satisfy a threshold measurement gap offset value.

Another UE for wireless communications is described. The UE may include means for receiving control signaling indicating a set of multiple on durations and a set of multiple off durations associated with a DRX cycle, means for receiving a WUS during a first MO, the WUS indicating for the UE to monitor during an on duration of the set of multiple on durations, where the on duration at least partially overlaps with a measurement gap, and means for monitoring, during the on duration based on the WUS, for a deactivation notification in a second MO during the on duration, where the monitoring is based on the on duration at least partially overlapping with the measurement gap, where the deactivation notification indicates to deactivate the measurement gap, and where a time offset between the second MO and the measurement gap satisfy a threshold measurement gap offset value.

A non-transitory computer-readable medium storing code for wireless communications is described. The code may include instructions executable by one or more processors to receive control signaling indicating a set of multiple on durations and a set of multiple off durations associated with a discontinuous reception cycle, receive a WUS during a first MO, the WUS indicating for the UE to monitor during an on duration of the set of multiple on durations, where the on duration at least partially overlaps with a measurement gap, and monitor, during the on duration based on the WUS, for a deactivation notification in a second MO during the on duration, where the monitoring is based on the on duration at least partially overlapping with the measurement gap, where the deactivation notification indicates to deactivate the measurement gap, and where a time offset between the second MO and the measurement gap satisfy a threshold measurement gap offset value.

Some examples of the method, user equipment (UEs), and non-transitory computer-readable medium described herein may further include operations, features, means, or instructions for receiving the deactivation notification in the second MO in accordance with the monitoring and monitoring, after the second MO, during the on duration in accordance with receiving the deactivation notification.

Some examples of the method, UEs, and non-transitory computer-readable medium described herein may further include operations, features, means, or instructions for refraining, after the second MO, from monitoring during a remaining time duration of the on duration based on failing to receive the deactivation notification in the second MO and performing one or more measurements during the measurement gap that at least partially overlaps with the on duration in accordance with failing to receive the deactivation notification in the second MO and based on refraining from monitoring during the on duration.

Some examples of the method, UEs, and non-transitory computer-readable medium described herein may further include operations, features, means, or instructions for monitoring, after the second MO, during a first portion of the on duration that does not overlap in time with the measurement gap based on failing to receive the deactivation notification in the second MO and performing a measurement during at least a portion of the measurement gap that overlaps in time with the on duration based on failing to receive the deactivation notification in the second MO.

Some examples of the method, UEs, and non-transitory computer-readable medium described herein may further include operations, features, means, or instructions for performing one or more measurements during the measurement gap via one or more frequency resources, where the threshold measurement gap offset value may be associated with a threshold time duration for the UE to tune to the one or more frequency resources.

In some examples of the method, UEs, and non-transitory computer-readable medium described herein, one or more symbols of the on duration overlaps with one or more symbols of the measurement gap.

Some examples of the method, UEs, and non-transitory computer-readable medium described herein may further include operations, features, means, or instructions for receiving the WUS during the first MO may be based on a second time offset between the first MO and a second on duration of the set of multiple on durations satisfying a threshold time gap value.

In some examples of the method, UEs, and non-transitory computer-readable medium described herein, the WUS includes a LP-WUS or a DCI signal.

A method for wireless communications by a UE is described. The method may include receiving control signaling indicating a set of multiple on durations and a set of multiple off durations associated with a DRX cycle, receiving second control signaling indicating a configuration of one or more measurement gaps, and refraining from performing a monitoring procedure via one or more MOs based on the DRX cycle and the configuration of the one or more measurement gaps satisfying one or more conditions.

A UE for wireless communications is described. The UE may include one or more memories storing processor executable code, and one or more processors coupled with the one or more memories. The one or more processors may individually or collectively be operable to execute the code to cause the UE to receive control signaling indicating a set of multiple on durations and a set of multiple off durations associated with a DRX cycle, receive second control signaling indicating a configuration of one or more measurement gaps, and refrain from performing a monitoring procedure via one or more MOs based on the DRX cycle and the configuration of the one or more measurement gaps satisfying one or more conditions.

Another UE for wireless communications is described. The UE may include means for receiving control signaling indicating a set of multiple on durations and a set of multiple off durations associated with a DRX cycle, means for receiving second control signaling indicating a configuration of one or more measurement gaps, and means for refraining from performing a monitoring procedure via one or more MOs based on the DRX cycle and the configuration of the one or more measurement gaps satisfying one or more conditions.

A non-transitory computer-readable medium storing code for wireless communications is described. The code may include instructions executable by one or more processors to receive control signaling indicating a set of multiple on durations and a set of multiple off durations associated with a DRX cycle, receive second control signaling indicating a configuration of one or more measurement gaps, and refrain from performing a monitoring procedure via one or more MOs based on the DRX cycle and the configuration of the one or more measurement gaps satisfying one or more conditions.

In some examples of the method, UEs, and non-transitory computer-readable medium described herein, refraining from performing the monitoring procedure based on the DRX cycle and the configuration of the one or more measurement gaps satisfying the one or more conditions may include operations, features, means, or instructions for refraining from monitoring for a deactivation notification in the one or more MOs based on the one or more conditions, where the one or more conditions includes receiving a WUS, the WUS indicating an on duration of the set of multiple on durations, where the on duration overlaps with a measurement gap of the one or more measurement gaps and monitoring during the on duration in accordance with the WUS.

In some examples of the method, UEs, and non-transitory computer-readable medium described herein, the WUS includes a LP-WUS or a DCI signal.

In some examples of the method, UEs, and non-transitory computer-readable medium described herein, refraining from performing the monitoring procedure based on the DRX cycle and the configuration of the one or more measurement gaps satisfying the one or more conditions may include operations, features, means, or instructions for refraining from monitoring for a WUS in the one or more MOs based on the one or more conditions, where the one or more conditions includes a measurement gap of the one or more measurement gaps at least partially overlapping with an on duration of the set of multiple on durations, the on duration associated with the WUS and performing one or more measurements during the measurement gap based on refraining from monitoring for the WUS.

In some examples of the method, UEs, and non-transitory computer-readable medium described herein, refraining from performing the monitoring procedure based on the DRX cycle and the configuration of the one or more measurement gaps satisfying the one or more conditions may include operations, features, means, or instructions for refraining from monitoring for a WUS in a MO of the one or more MOs based on the one or more conditions, where the one or more conditions includes a measurement gap of the one or more measurement gaps overlapping with the MO and performing one or more measurements during the measurement gap based on refraining from monitoring for the WUS.

In some examples of the method, UEs, and non-transitory computer-readable medium described herein, the WUS includes a LP-WUS or a DCI signal.

In some examples of the method, UEs, and non-transitory computer-readable medium described herein, the one or more conditions may be based on a first priority level associated with a measurement gap of the one or more measurement gaps, and a second priority level associated with an on duration of the set of multiple on durations.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports measurement gap deactivation timing in accordance with one or more aspects of the present disclosure.

FIGS. 2 through 5 show examples of timing diagrams that support measurement gap deactivation timing in accordance with one or more aspects of the present disclosure.

FIG. 6 through 8 show examples of process flows that support measurement gap deactivation timing in accordance with one or more aspects of the present disclosure.

FIGS. 9 and 10 show block diagrams of devices that support measurement gap deactivation timing in accordance with one or more aspects of the present disclosure.

FIG. 11 shows a block diagram of a communications manager that supports measurement gap deactivation timing in accordance with one or more aspects of the present disclosure.

FIG. 12 shows a diagram of a system including a device that supports measurement gap deactivation timing in accordance with one or more aspects of the present disclosure.

FIGS. 13 through 15 show flowcharts illustrating methods that support measurement gap deactivation timing in accordance with one or more aspects of the present disclosure.

### DETAILED DESCRIPTION

In some wireless communications systems, a UE may be configured to use a (DRX) cycle. The DRX cycle may include on and off durations for the UE, such that the UE may expend a reduced amount of power (e.g., may enter sleep modes, ultra-deep sleep modes, power off modes, etc.) during off durations, while powering on to participate in communication (e.g., waking up) during on durations. Using a DRX cycle may reduce latency and save power, among other advantages. In some cases, a network entity may transmit wakeup signals (WUS) (e.g., downlink control information (DCI), low-power wake-up signals (LP-WUS)) to indicate to the UE to wake up during an on duration. In some cases, if a WUS is not received during an associated monitoring occasion (MO), the UE may skip the next on duration (e.g., the UE may not wake up). In some implementations, the MO for the WUS may occur according to timing parameters associated with the DRX cycle. For example, the WUS MO may occur at least a threshold time gap prior to the on duration it is associated with. Additionally, or alternatively, there may be an offset (e.g., which may be referred to as a ps_offset) from the beginning of the on duration that defines the window in which such an MO may occur. For example, a WUS MO may occur within the offset, before the beginning of the next on duration.

In some cases, the UE may also be configured to perform measurements on a serving cell and neighboring cells during a measurement gap (e.g., for facilitating handover procedures). To perform a measurement, the UE may tune to a frequency associated with a neighboring cell before the measurement gap occurs. The UE may take some amount of time to perform this tuning. The amount of time to perform the tuning may be associated with a measurement gap offset. During the tuning process and the measurement gap, the UE may not be in communication with a serving cell. That is, the UE may not communicate with the serving cell for the measurement gap offset and the measurement gap length. For example, during the measurement gap offset and the measurement gap, the UE may be operating at a frequency different from that associated with the serving cell. In these cases, the UE may not transmit or receive data, resulting in packet delay or loss.

In some examples, a measurement gap may overlap with a WUS MO or an on duration for a DRX cycle. In such examples, packet delay or loss, as well as any inefficiency, may be exacerbated. The UE may receive a deactivation notification via an MO of an on duration, the deactivation notification indicating for the UE to cancel the measurement gap. However, the MO for the deactivation notification may be associated with timing constraints at the UE.

In some examples, the measurement gap may overlap or partially overlap with a WUS MO. In some such examples, the UE may monitor for a deactivation notification for the measurement gap, but the deactivation notification or the MO for the deactivation notification may not occur until after the offset form the measurement gap. The UE may not be able to cancel the measurement gap, as the deactivation notification may have been sent at a timing that is too close to the measurement gap, and the UE may miss the WUS. When the UE misses the WUS, the UE may not wake up during an associated on duration and may fail to receive or transmit wireless communications.

In some cases, the measurement gap may overlap or partially overlap with an on duration. The UE may miss part of the on duration to perform measurements in the measurement gap and thus fail to receive communications, or, additionally, or alternatively, the UE may fail to deactivate the measurement gap when a deactivation notification may not be sent prior to the offset from the measurement gap. As a result, the UE may miss signals for data transmission or reception based on performing measurements. In some cases, the UE may not perform measurements based on monitoring for signals associated with the DRX cycle based on an overlap between a measurement gap and a WUS MO or an on duration.

Techniques described herein provide for measurement gap deactivation timing at a UE to coordinate timing constraints for DRX cycles, measurement gaps, and measurement gap deactivation notifications. In some implementations, a measurement gap may overlap with a WUS MO. In some cases, if a measurement gap overlaps with a WUS MO, the measurement gap may be prioritized. In other cases, the MO may be prioritized. In some examples, a network entity may send the UE a deactivation notification indicating for the UE to deactivate the measurement gap. The network entity may ensure that the deactivation notification is sent via DCI in a valid MO according to one or more timing rules or conditions (e.g., via an on duration of the DRX cycle, earlier than a measurement gap offset from the measurement gap). In some examples, receiving the WUS may implicitly cancel the measurement gap.

Additionally, or alternatively, a measurement gap may overlap with an on duration. In some cases, if the measurement gap overlaps with an on duration, the measurement gap may be prioritized and the WUS MO for the on duration may not be monitored. In some implementations, the UE may monitor for a WUS indicating the on duration and, additionally, or alternatively, may monitor for a deactivation notification for the measurement gap within a valid MO (i.e., before the measurement gap offset from the measurement gap and within an on duration). In some examples, the UE may receive a WUS for the overlapping on duration, and may cancel the measurement gap that overlaps with the indicated on duration based on receiving the WUS. Additionally, or alternatively, in some cases, the UE may receive the deactivation notification according to one or more timing constraints (e.g., during the on duration but before the mg-offset prior to the overlapping measurement gap) and the UE may cancel the measurement gap and monitor during the on duration. In other cases, the UE may not receive the deactivation notification. In some examples, the UE may cancel the on duration and perform measurements in the measurement gap based on not receiving the deactivation notification. In some cases, the UE may truncate or shorten the on duration to allow time for the UE to tune to a new frequency a perform measurements in the measurement gap (i.e., shorten the on duration until the measurement gap offset) based on not receiving the deactivation notification.

Aspects of the disclosure are initially described in the context of wireless communications systems, timing diagrams, and process flows. Aspects of the disclosure are further illustrated by and described with reference to apparatus diagrams, system diagrams, and flowcharts that relate to measurement gap deactivation timing.

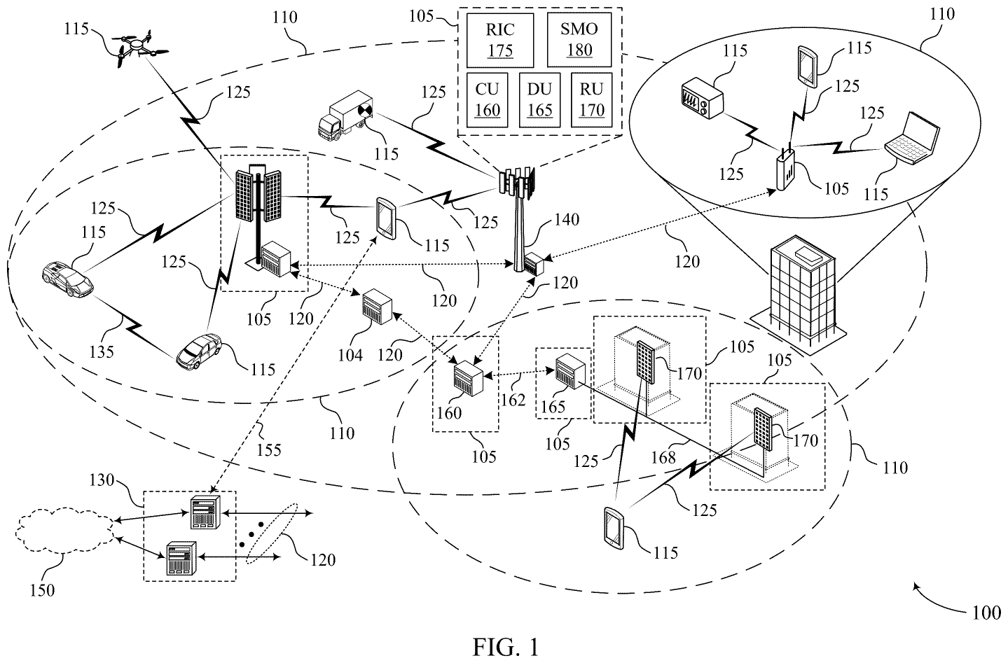

FIG. 1 shows an example of a wireless communications system 100 that supports measurement gap deactivation timing in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems 100, a UE 115 may be configured to use a DRX cycle, which may reduce latency and save power, among other advantages. The DRX cycle may include a cycle of on and off durations for the UE 115, such that the UE 115 may use minimal power (e.g., sleep, ultra-deep sleep, power off) during off durations, while powering on to participate in communication (e.g., waking up) during on durations. In some cases, a network entity 105 may use a WUS (e.g., DCI, LP-WUS) to indicate to the UE 115 to wake up during an on duration. In some cases, if a WUS is not received during an associated MO, the UE 115 may skip the next on duration (e.g., the UE may not wake up). In some implementations, the MO for the WUS may occur according to timing parameters associated with the DRX cycle. For example, there may be a minimum time gap defined before the beginning of an on duration where the UE 115 may not monitor for a WUS. That is, the WUS MO may occur at least a minimum time gap prior to the on duration it is associated with. Additionally, or alternatively, there may be an offset (e.g., ps_offset) from the beginning of the on duration that defines the window in which a MO may occur. For example, a WUS MO may occur within the offset, before the beginning of the next on duration.

In some cases, the UE 115 may also be configured to perform measurements, during a measurement gap, on a serving cell and neighboring cells, such as for facilitating handover procedures. To perform a measurement, the UE 115 may tune to a frequency associated with a neighboring cell before the measurement gap. The UE 115 may take some amount of time to perform this tuning. The amount of time to perform the tuning may be associated with a measurement gap offset. During the tuning process and the measurement gap, the UE 115 may not be in communication with a serving cell. That is, the UE 115 may not communicate with the serving cell for the measurement gap offset and the measurement gap length. For example, the UE 115 may be operating at a frequency different from that associated with the serving cell for the measurement gap offset and the measurement gap. In these cases, the UE 115 may not transmit or receive data, resulting in packet delay or loss.

In some cases, a measurement gap may overlap with a WUS MO or an on duration for a DRX cycle. In these examples, packet delay and loss, as well as any efficiency issues, may be exacerbated. In some implementations, the measurement gap may be canceled. The UE 115 may receive a deactivation notification in a MO of an on duration, the deactivation notification indicating for the UE 115 to cancel the measurement gap. However, the MO for the deactivation notification may be associated with further timing constraints. For example, the MO may occur within an on duration of the DRX cycle and prior to the measurement gap offset for the measurement gap, which may lead to more timing constraints at the UE 115. That is, the UE 115 may not have a defined procedure for defining timing between DRX cycles, measurement gaps, and deactivation notifications for measurements gaps. As a result, the UE 115 may miss signals for data transmission or reception based on performing measurements, or vice versa.

However, the network entity 105 and the UE 115 may utilize measurement gap deactivation timing at the UE 115 to coordinate monitoring occasions and measurement occasions according to timing constraints for DRX cycles, measurement gaps, and measurement gap deactivation notifications. In some implementations, a measurement gap may overlap with a WUS MO. In some cases, if a measurement gap overlaps with a WUS MO, the measurement gap may be prioritized. That is, the UE 115 may perform a measurement in the measurement gap and refrain from monitoring during the WUS MO. In other cases, the WUS MO may be prioritized. That is, the UE 115 may monitor during the WUS MO and refrain from performing a measurement in the measurement gap. In some examples, a network entity 105 may send the UE 115 a deactivation notification indicating for the UE 115 to deactivate the measurement gap. The deactivation notification may be sent via DCI via a valid MO (e.g., via an on duration of the DRX cycle, earlier than a measurement gap offset from the measurement gap).

Additionally, or alternatively, a measurement gap may overlap with an on duration. In some cases, if the measurement gap overlaps with an on duration, the measurement gap may be prioritized and the WUS MO for the on duration may not be monitored. In some cases, the UE 115 may monitor for a WUS indicating the on duration and, additionally, or alternatively, may monitor for a deactivation notification for the measurement gap within a valid MO (i.e., before the measurement gap offset from the measurement gap and within an on duration). In some examples, the UE 115 may receive a WUS and may cancel the measurement gap based on receiving the WUS. Additionally, or alternatively, in some cases, the UE 115 may receive the deactivation notification and the UE 115 may cancel the measurement gap and monitor during the on duration. In other cases, the UE 115 may not receive the deactivation notification. In some examples, the UE 115 may cancel the entire on duration and perform measurements in the measurement gap based on not receiving the deactivation notification. In some examples, the UE 115 may truncate or shorten the on duration to allow time for the UE 115 to tune to a new frequency a perform measurements in the measurement gap (i.e., shorten the on duration until the measurement gap offset) based on not receiving the deactivation notification.

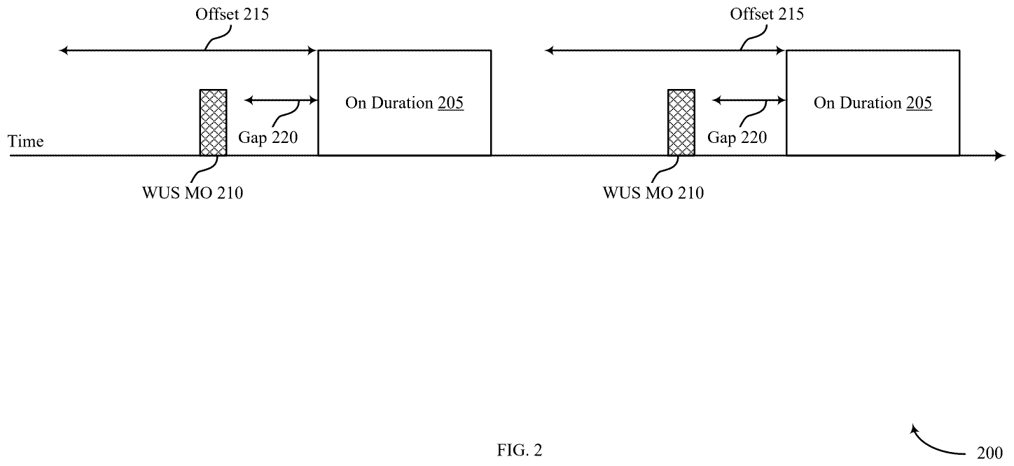

FIG. 2 shows an example of a timing diagram 200 that supports measurement gap deactivation timing in accordance with one or more aspects of the present disclosure. In some examples, aspects of the timing diagram 200 may implement, or be implemented by, aspects of the wireless communications system 100. For example, the timing diagram 200 may be implemented by a UE, which may be an example of the corresponding devices as described herein, including with reference to FIG. 1. The techniques described in the context of the timing diagram 200 may provide techniques that support the implementation of a DRX cycle at the UE, with associated timing constraints that support the implementation of measurement gap deactivation timing procedures.

In some wireless communications systems, a UE may be configured to operate according to a DRX cycle or other power savings modes that may have full power and low power durations, or on and off durations. Operating according to a DRX cycle or power savings mode may reduce latency and save power, among other advantages. For example, a DRX cycle may include a cycle of on durations 205 and off durations for the UE, such that the UE may expend reduced power (e.g., sleep mode, power off mode, etc.) during off durations, while powering on to participate in communication (e.g., waking up) during on durations 205. In some cases, a network entity may transmit a WUS (e.g., DCI, low power wake-up signals (LP-WUS)), received via a WUS MO 210, to indicate to the UE to wake up during an on duration 205. In some cases, if a WUS is not received during a WUS MO 210, the UE may skip the next on duration 205 (e.g., the UE may not wake up).

The WUS associated with a WUS MO 210 may be an LP-WUS or a DCI WUS (e.g., DCI format 2_6). The timing constraints (e.g., timeline) may differ depending on the type of WUS, but both the LP-WUS and DCI WUS may be associated with timing constraints that are defined with respect to a timing (e.g., a slot) where the on duration 205 may begin (e.g., when a drx-onDurationTimer may start).

In some implementations, the WUS MO 210 may be associated with a DCI WUS (e.g., DCI format 2_6), which may occur according to timing parameters associated with the DRX cycle. The DCI WUS may be a DCI with a cyclic redundancy check (CRC) scrambled by power saving radio network temporary identifier (PS-RNTI) (DCP). In some cases, a search space set may be configured for monitoring for the DCI WUS via the WUS MO 210. In the WUS MO 210, the UE may monitor PDCCH occasions during a period of time (e.g., a duration) defined by an offset 215 (e.g., ps_offset) and a gap 220 (e.g., minimum time gap). That is, there may be an offset 215 (e.g., ps_offset) from the beginning of the on duration 205 that defines the window in which a WUS MO 210 may occur. For example, a WUS MO 210 may occur within the offset 215, before the beginning of the next on duration 205 (i.e., before the initiation of a timer (e.g., drx-onDurationTimer) for the next on duration 205). The offset 215 may be defined in units of milliseconds. The offset 215 may be indicated by a network entity (e.g., via control signaling).

Additionally, or alternatively, there may be a gap 220 defined before the beginning of an on duration 205 where the UE may not monitor for a WUS. That is, the gap 220 may be a time duration prior to when a timer (e.g., drx-onDurationTimer) may start for the next on duration 205, within which the UE may not monitor for the DCI WUS (e.g., within which a WUS MO 210 may not occur). The gap 220 may be dependent on the capability of the UE and may be in units of slots (e.g., it may be subcarrier spacing (SCS) dependent). For each SCS supported by the UE, the UE may report or use one value of two candidate values for the gap 220. In some cases, the maximum or greatest value for the gap may be 3 ms. That is, the WUS MO 210 may occur at least a gap 220 prior to the on duration 205 that it is associated with and within the offset 215 prior to the on duration 205. In some cases, the WUS MO 210 may occur during a duration (e.g., a slot). The slot may be divided into symbols where some symbols may be monitored as MOs. For example, there may be specific PDCCH MOs within a slot duration. For example, a slot may include 12 symbols and a subset of symbols (e.g., the first two symbols) may form a WUS MO 210 and another subset of symbols (e.g., the sixth and seventh symbols) may form a WUS MO 210 (e.g., in the case of a 1-symbol control resource set (CORESET)). There may also be some synchronization signal (SS) set periodicity associated with the DRX cycle and the WUS MO 210. The periodicity may also be defined in slots. In some examples, the network entity may schedule the WUS MOs 210 to occur within the offset 215 and prior to the gap 220 for a given on duration 205.

In some implementations, the WUS MO 210 may be associated with an LP-WUS, which may occur according to timing parameters associated with the DRX cycle or, in some cases, different power modes. For example, the UE may monitor for the LP-WUS via a WUS MO 210 that may occur at least a gap 220 prior to the start of the on duration 205 (e.g., before the slot that a drx-onDurationTimer may be initiated). The LP-WUS may indicate to the UE to monitor during the on duration 205 (e.g., monitor PDCCH in the DRX active time, or on duration 205, of the DRX cycle). The WUS MO 210 for the LP-WUS may be associated with a low power wakeup radio (LP-WUR) (e.g., LR) or a receive-only radio, which may be associated with a low power mode. That is, the UE may monitor for an LP-WUS while operating in a low power mode using the LP-WUR. If the UE detects an LP-WUS via the WUS MO 210, the UE may transition to a main radio (MR) to monitor during the on duration 205. That is, the UE may transition from a low power mode using an LP-WUR to a different power mode using an MR for a next on duration 205 if the UE receives the LP-WUS during a WUS MO 210.

The LP-WUS may be associated with multiple parameters and functional expectancies. For example, the LP-WUS may be used regardless of a state of connectivity between the UE and a serving cell. For example, the UE may still monitor for and receive an LP-WUS in idle, inactive, and connected modes (e.g., RRC_IDLE, RRC_INACTIVE, RRC_CONNECTED), wherein the different connectivity modes relate to different levels of connectivity between the UE and the serving cell. In some cases, the LP-WUS may be on-off keying (OOK) based (e.g., OOK-1, OOK-4). In some examples, there may be an OFDM sequence overlaid over the OOK symbol. In some cases, the LP-WUS may indicate that the same information may be delivered during an idle or inactive mode for any type of LP-WUR. The OFDM sequence may carry the information. In some implementations, duty-cycled monitoring of the LP-WUS may be supported.

In idle or inactive modes, there may be specific procedures and configurations for an LP-WUS to indicate paging monitoring, as triggered by the LP-WUS, which may include a configuration, sub-grouping, and entry and exit conditions for LP-WUS monitoring. There may be a low power synchronization signal (LP-SS) with a periodicity, which may be defined in milliseconds, that may be used for synchronization and radio resource management (RRM) for the serving cell. The periodicity of the LP-SS may be determined by the UE or a network entity, where there may be some starting value (e.g., 320 ms) for determining the optimal or appropriate periodicity of the LP-SS. The LP-SS may be based on the OOK waveform, with or without overlaid OFDM sequences. In some cases, the UE or the network entity may select the OOK waveform to be with or without the overlaid OFDM sequences. In some cases, an LP-WUR may be able to receive a primary synchronization signal (PSS) or secondary synchronization signal (SSS). In these cases, the existing PSS or SSS may be used for synchronization and RRM, rather than the LP-SS. In some implementations, RRM or some of the RRM may occur at the LP-WUR for measurements of the serving cell and of neighboring cells. That is, the UE may offload serving cell RRM measurements and neighboring cell RRM measurements from the MR to the LP-WUR, including offloading any conditions for completing these measurements.

In connected modes (e.g., RRC_CONNECTED), there may be specific procedures and configurations to allow the MR at a UE to monitor during on durations 205 (e.g., PDCCH monitoring) when triggered by the LP-WUS. This may include procedures for activating and deactivating LP-WUS monitoring, or deactivating a WUS MO 210. In a connected mode, the UE may use the MR and may not enter a sleep mode (e.g., ultra-deep sleep). That is, RRM, radio link monitoring (RLM), beam failure detection (BFD), channel state information (CSI), and associated measurements may be performed by the MR.

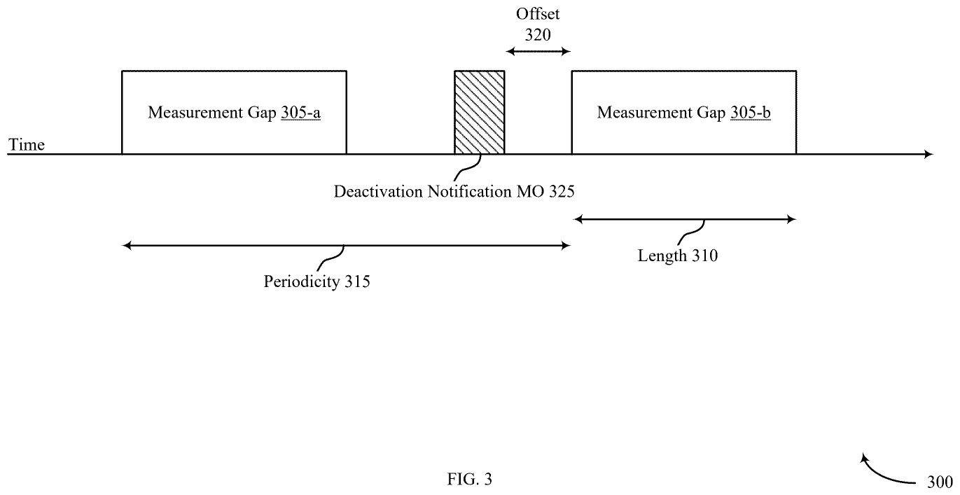

In some cases, as described further with reference to FIG. 3, the UE may also be configured to perform measurements on a serving cell and neighboring cells during a measurement gap (e.g., for facilitating handover procedures). To perform a measurement, the UE may tune to a frequency associated with a neighboring cell before the measurement gap occurs. The UE may take some amount of time to perform this tuning. The amount of time to perform the tuning may be associated with a measurement gap offset. During the tuning process and the measurement gap, the UE may not be in communication with a serving cell. That is, the UE may not communicate with the serving cell for the measurement gap offset and the measurement gap length. For example, during the measurement gap offset and the measurement gap, the UE may be operating at a frequency different from that associated with the serving cell. In these cases, the UE may not transmit or receive data, resulting in packet delay or loss.

In some examples, a measurement gap may overlap with a WUS MO 210 or an on duration 205 for a DRX cycle.

In some implementations, a measurement gap may overlap with a WUS MO 210. In some cases, if a measurement gap overlaps with a WUS MO 210, the measurement gap may be prioritized. That is, the UE 115 may perform a measurement in the measurement gap and refrain from monitoring during the WUS MO 210. In other cases, the WUS MO 210 may be prioritized. That is, the UE may monitor during the WUS MO 210 and refrain from performing a measurement in the measurement gap. In some examples, a network entity 105 may send the UE 115 a deactivation notification indicating for the UE 115 to deactivate the measurement gap. The deactivation notification may be sent via DCI via a valid MO (e.g., via an on duration 205 of the DRX cycle, earlier than a measurement gap offset from the measurement gap).

Additionally, or alternatively, a measurement gap may overlap with an on duration 205. In some cases, if the measurement gap overlaps with the on duration 205, the measurement gap may be prioritized and the WUS MO 210 for the on duration 205 may not be monitored. In some implementations, the UE may monitor for a WUS indicating the on duration 205 and, additionally, or alternatively, may monitor for a deactivation notification for the measurement gap within a valid MO (i.e., before the measurement gap offset from the measurement gap and within an on duration 205). In some examples, the UE may receive a WUS for the overlapping on duration 205 via a WUS MO 210, and may cancel the measurement gap based on receiving the WUS. Additionally, or alternatively, in some cases, the UE may receive the deactivation notification according to one or more timing constraints (e.g., during the on duration but before the mg-offset prior to the overlapping measurement gap) and the UE may cancel the measurement gap and monitor during the on duration 205. In other cases, the UE may not receive the deactivation notification. In some examples, the UE may cancel the on duration 205 and perform measurements in the measurement gap based on not receiving the deactivation notification. In some cases, the UE may truncate or shorten the on duration 205 to allow time for the UE to tune to a new frequency a perform measurements in the measurement gap (i.e., shorten the on duration 205 until the measurement gap offset) based on not receiving the deactivation notification.

FIG. 3 shows an example of a timing diagram 300 that supports measurement gap deactivation timing in accordance with one or more aspects of the present disclosure. In some examples, aspects of the timing diagram 300 may implement, or be implemented by, aspects of the wireless communications system 100. For example, the timing diagram 300 may be implemented by a UE, which may be an example of the corresponding devices as described herein, including with reference to FIG. 1. The techniques described in the context of the timing diagram 300 may provide techniques that support the implementation of a measurement procedure at the UE, with associated timing constraints that support the implementation of measurement gap 305 deactivation timing procedures.

In some wireless communication systems, a UE may perform measurements on neighboring cells, such as by measuring sounding reference signals (SRS) of neighboring cells. The UE may perform the measurements during measurement gaps 305, which may be configured by a network entity. When a measurement gap 305 occurs, the UE may not be able to transmit, receive, or otherwise communicate within its own cell (e.g., with the network entity). For example, the UE may tune to another frequency range to perform a measurement, and may fail to receive or transmit signaling during the measurement gap (e.g., due to retuning for the measurements during the measurement gaps 305). Measurement gaps 305 are defined by measurement gap parameters, such as the length 310 of the measurement gap 305, a quantity of repetitions of the measurement gap 305, a periodicity 315 of the measurement gap 305, and an offset 320 of the measurement gap 305 (e.g., an offset 320 allowing for the UE to tune to the frequency range being measured in the measurement gap 305).

In some cases, measurement gaps 305 may correspond to a higher priority than other data traffic. For example, a measurement gap 305 may overlap with a normal data transmission. The measurement gap 305 may have priority and the normal data transmission may not be received. Moreover, the periodicity 315 of measurement gaps 305 may be defined in values (e.g., 20/40/80/160 ms) that may not be aligned with normal data transmission or other types of data transmission (e.g., extended reality (XR)) periodicity, which may be defined in units such as frames per second or Hertz. That is, in some cases, it may not be possible to avoid some conflict between the measurement gaps 305 and other data transmissions. Conflicts caused by the measurement gaps 305 may cause frequent packet delays and increasing of packet delay over time, which may affect the ability to meet a packet delay budget (PDB) requirement in data transmission applications. This may be particularly pertinent in types of data transmission with high PDB requirements (e.g., XR, which may have a PDB requirement of 99% of packets).

To address the impact of the timing of measurement gaps 305, some wireless communications systems may support sending a deactivation notification via an associated deactivation notification MO 325. The deactivation notification may indicate that a measurement gap 305 (e.g., the measurement gap 305-a or the measurement gap 305-b) is to be canceled or deactivated (e.g., no measurement is performed). That is, a deactivation notification received via the deactivation notification MO 325 may indicate that measurement gap 305-b is to be deactivated or canceled. The deactivation notification may be a DCI. The deactivation notification MO 325 may occur at some time prior to the measurement gap 305 and the offset 320 (e.g., mg_offset). For example, a deactivation notification sent within the offset 320 may not be received by the UE because the UE may have already tuned to a new frequency in which to perform the measurement associated with the measurement gap 305-b. Thus, the deactivation notification MO 325 may occur prior to the offset 320 from the start of the measurement gap 305 that the deactivation notification is associated with (e.g., measurement gap 305-b) to respect tuning procedures associated with the measurement gap 305.

Some wireless communications may support low power or DRX cycle configurations. In these cases, deactivation notification MOs 325 may occur when a UE is awake or powered on (e.g., during an on duration), which may be associated with timing constraints such as timing gaps and offsets, as described further with reference to FIG. 2. In some implementations, a measurement gap 305 may overlap with an on duration or a WUS MO for an on duration, which may cause the UE to fail to receive communications or fail to perform measurements in the measurement gap 305. In some cases, the UE may monitor for a deactivation notification to determine whether to perform the measurement in the overlapping measurement gap 305. In some examples, the UE may assume the measurement gap 305 may be deactivated based on the overlap. That is, the UE may prioritize the WUS MO or the on duration that may overlap with the measurement gap 305. In some implementations, the UE may perform an operation for determining when to deactivate a measurement gap 305 in the case of an overlap.

In some cases, a measurement gap 305 may overlap with a WUS MO. In some examples, the measurement gap 305 may be prioritized. In other examples, the WUS MO may be prioritized. In some examples, a network entity may send the UE a deactivation notification indicating for the UE to deactivate the measurement gap. The network entity may ensure that the deactivation notification is sent via DCI in a valid deactivation notification MO 325 according to one or more timing rules or conditions (e.g., via an on duration of the DRX cycle, earlier than an offset 320 from the measurement gap 305).

Additionally, or alternatively, the measurement gap 305 may overlap with an on duration. In some examples, if the measurement gap 305 overlaps with an on duration, the measurement gap 305 may be prioritized and the WUS MO for the on duration may not be monitored. In some implementations, the UE may monitor for a WUS indicating the on duration and, additionally, or alternatively, may monitor for a deactivation notification for the measurement gap 305 within a deactivation notification MO 325 (i.e., before the offset 320 from the measurement gap 305 and within an on duration). In some examples, the UE may receive a WUS for the overlapping on duration, and may cancel the measurement gap 305 that overlaps with the indicated on duration based on receiving the WUS. That is, receiving a WUS via the WUS MO may implicitly cancel the measurement gap 305. Additionally, or alternatively, in some cases, the UE may receive the deactivation notification in the deactivation notification MO 325 according to one or more timing constraints (e.g., during the on duration but before the mg-offset prior to the overlapping measurement gap) and the UE may cancel the measurement gap 305 and monitor during the on duration. In other cases, the UE may not receive the deactivation notification. In some examples, the UE may cancel the entire on duration and perform measurements in the measurement gap 305 based on not receiving the deactivation notification. In some cases, the UE may truncate or shorten the on duration to allow time for the UE to tune to a new frequency a perform measurements in the measurement gap 305 (i.e., shorten the on duration until the offset 320) based on not receiving the deactivation notification.

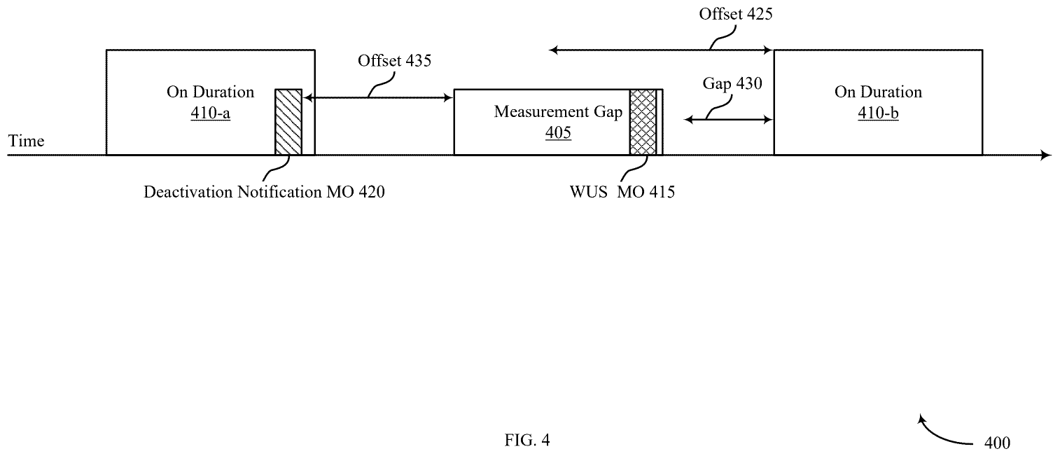

FIG. 4 shows an example of a timing diagram 400 that supports measurement gap 405 deactivation timing in accordance with one or more aspects of the present disclosure. In some examples, aspects of the timing diagram 400 may implement, or be implemented by, aspects of the wireless communications system 100. For example, the timing diagram 400 may be implemented by a UE, which may be an example of the corresponding devices as described herein, including with reference to FIG. 1. The techniques described in the context of the timing diagram 400 may support deactivation timing procedures for measurement gaps 405 during configured DRX cycles of on durations 410, particularly when a measurement gap 405 overlaps with a WUS MO 415.

As described further with respect to FIGS. 2 and 3, the on durations 410 and the measurement gap 405 may be subject to or associated with one or more timing constraints that define a WUS MO 415 and a deactivation notification MO 420. For example, the WUS MO 415 may occur within an offset 425 (e.g., ps_offset) from the beginning of an on duration 410-b, but prior to a gap 430 from the beginning of the proceeding on duration 410. The WUS associated with the WUS MO 415 may be an LP-WUS or a DCI WUS. The timing constraints may differ depending on the type of WUS, but the LP-WUS and DCI WUS may be associated with timelines that may be defined with respect to a slot where an on duration 410 may begin (e.g., when a drx-onDurationTimer may start). Additionally, or alternatively, the deactivation notification MO 420 may occur within an on duration 410-a but prior to an offset 435 (e.g., mg_offset) from the measurement gap 405. The deactivation notification associated with the deactivation notification MO 420 may be a DCI with timing constraints defined with respect to the first measurement gap 405 that may be canceled by the deactivation notification. The offset 435 may be associated with a tuning procedure for the UE to perform measurements in the measurement gap 405.

In some implementations, a WUS MO 415 may overlap with a measurement gap 405. In some cases, a UE may prioritize the measurement gap 405. That is, the UE may refrain from monitoring during the WUS MO 415. Instead, the UE may perform measurements in the measurement gap 405. In such examples, the UE may fail to receive a WUS during the WUS MO 415 (e.g., the network entity may refrain from transmitting a WUS during the WUS MO 415 based on the prioritization of the measurement gap 405). If signaling is pending, the network entity may wait to trigger the signaling for a subsequent on duration (e.g., via a WUS MO that does not overlap with a measurement gap 405). In some cases, the UE may monitor for a deactivation notification within the deactivation notification MO 420 based on the WUS MO 415 overlapping with the measurement gap 405. The deactivation notification may indicate to cancel the measurement gap 405.

In some implementations, the UE may receive the deactivation notification via the deactivation notification MO 420, where the deactivation notification MO 420 occurs within the on duration 410-a and prior to the offset 435 for the measurement gap 405. For example, the network entity may generate downlink signaling or trigger uplink signaling that is to be transmitted during the on duration 410-b. To ensure that the UE is able to receive the downlink signaling or transmit the uplink signaling, the network entity may transmit a WUS via a WUS MO 415. The network entity may ensure that transmission of the WUS occurs within the offset 425 from the initiation of the on duration 410-b, and prior to the gap 430 measured from the initiation of the on duration 410-b For example, the the network entity may schedule the WUS MO 415 within the offset 425 and prior to the gap 430, or may select the WUS MO 415 from a set of candidate or available WUS MOs based on the WUS MO415 satisfying both the offset 425 and the gap 430. In some examples (e.g., if the WUS is a DCI message), the network entity may initiate transmission of the WUS (e.g., may select available PDCCH symbols corresponding to a WUS MO) to satisfy the offset 425 and the gap 430. However, the network entity may also determine that the WUS MO 415 (e.g., which satisfies the offset 425 and the gap 430) occurs during (e.g., at least partially overlaps with) the measurement gap 405.

The network entity may determine to deactivate the measurement gap 405 so that the UE will be able to receive the WUS via the WUS MO 415. If the network entity fails to transmit the deactivation notification prior to the offset 435 from the initiation of the measurement gap 405, then the UE may fail to receive the deactivation notification and may tune away for measurements during the measurement gap, fail to receive the WUS via the WUS MO 415, and fail to perform the pending wireless communications during the on duration 410-b. Thus, the network entity may ensure transmission of the deactivation notification via the deactivation notification MO 420 (e.g., which occurs prior to the offset 435 from initiation of the measurement gap 405). The network entity may select or schedule resources for the deactivation notification MO 420 to satisfy the offset 435, or may otherwise ensure transmission of the deactivation notification prior to the offset 435 (e.g., during the on duration 410-a).

Techniques described herein may support the network entity in ensuring that a WUS for the on duration 410-b is received by ensuring transmission of the WUS to satisfy timing constraints (e.g., the gap 430 and the offset 425), and ensuring that a deactivation notification for a measurement gap that overlaps with the WUS MO 415 for the WUS is transmitting to satisfy timing constraints (e.g., the offset 435). The network entity may schedule or transmit the deactivation notification, the WUS, or both, according to one or more rules or conditions. The network may autonomously determine such timing, or schedule the deactivation notification MO 420 and the WUS MO 415 to satisfy such constraints. In some examples, scheduling of the deactivation notification MO 420, the WUS MO 415 or both, or transmission of the deactivation notification, the WUS, or both, to satisfy such timing constraints, may be accomplished according to one or more rules, which may be defined in one or more standards documents. The network entity may then transmit the deactivation notification at least the offset 435 prior to the measurement gap, and may transmit the WUS during the measurement gap via the WUS MO 415 according to the offset 425 and the gap 430, according to the one or more rules.

The UE may receive the deactivation notification via the deactivation notification MO 420, and may deactivate the measurement gap 405. The UE may proceed to monitor for a WUS via the WUS MO 415 based on receiving the deactivation notification. The UE may receive the WUS (e.g., DCI, LP-WUS) via the WUS MO 415. The WUS may indicate for the UE to monitor during the on duration 410-b (e.g., wake for the next on duration 410-b).

In some cases, the WUS may be an LP-WUS and, in some examples, may be monitored without a configured DRX cycle. That is, the UE may monitor for an LP-WUS to determine whether to shift power modes (e.g., shift from a low power radio to a main radio), as discussed further with respect to FIG. 2 without reference to a DRX cycle or a specific on duration.

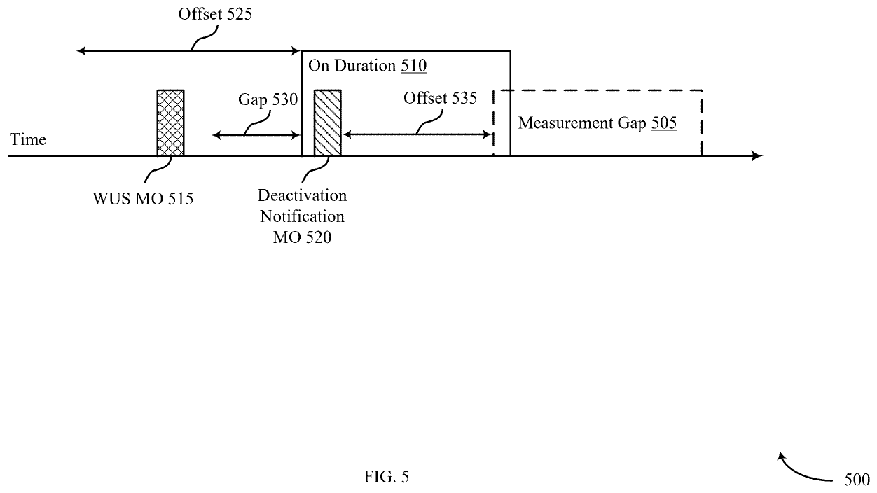

FIG. 5 shows an example of a timing diagram 500 that supports measurement gap 505 deactivation timing in accordance with one or more aspects of the present disclosure. In some examples, aspects of the timing diagram 500 may implement, or be implemented by, aspects of the wireless communications system 100. For example, the timing diagram 500 may be implemented by a UE, which may be an example of the corresponding devices as described herein, including with reference to FIG. 1. The techniques described in the context of the timing diagram 500 may provide deactivation timing procedures for measurement gaps 505 during configured DRX cycles, particularly when a measurement gap 505 overlaps with an on duration 510 of a DRX cycle.

As described further with respect to FIGS. 2 and 3, the on duration 510 and the measurement gap 505 may have associated timing constraints for a WUS MO 515 and a deactivation notification MO 520. For example, the WUS MO 515 may occur within an offset 525 (e.g., ps_offset) from the beginning of the on duration 510, but prior to a gap 530 from the beginning of the on duration 510. The WUS associated with the WUS MO 515 may be an LP-WUS or a DCI WUS. The timing constraints may differ depending on the type of WUS, but the LP-WUS and DCI WUS may be associated with timelines that are defined with respect to a slot where an on duration 510 may begin (e.g., when a drx-onDurationTimer may start). Additionally, or alternatively, the deactivation notification MO 520 may occur within the on duration 510 but prior to the offset 535 (e.g., mg_offset) from the measurement gap 505. The deactivation notification associated with the deactivation notification MO 520 may be a DCI with associated timing constraints defined with respect to the first measurement gap 505 that may be canceled by the deactivation notification. The offset 535 may be associated with a tuning procedure for the UE to perform measurements in the measurement gap 505.

In some implementations, an on duration 510 may overlap or partially overlap with a measurement gap 505. For example, some symbols of the measurement gap 505 may overlap with some symbols of the on duration 510. In some cases, the measurement gap 505 may have a higher priority than the on duration 510. That is, a measurement may be performed in the measurement gap 505 and the UE may refrain from monitoring during the on duration 510 based on the on duration 510 overlapping with the measurement gap 505. In some examples, the UE may refrain from monitoring for a WUS within the WUS MO 515. That is, the UE may assume the on duration 510 may not be monitored based on the on duration 510 overlapping with the measurement gap 505, and thus may not monitor for a WUS within the WUS MO 515 associated with the on duration 510 (e.g., the UE may not be expected to monitor for valid LP-WUS or DCI WUS associated with the on duration 510 because the on duration 510 overlaps with the higher priority measurement gap 505).

In some cases, the on duration 510 may have a higher priority than the measurement gap 505. That is, the UE may assume the measurement gap 505 is deactivated because it overlaps with the on duration 510, and may perform communications or monitor for signaling during the on duration 510. In some examples, the UE may refrain from monitoring for the deactivation notification during the deactivation notification MO 520 based on the overlapping on duration 510. That is, the UE may assume the measurement gap 505 is deactivated based on the overlap between the on duration 510 and the measurement gap 505, and thus may not monitor for a deactivation notification for the measurement gap 505 during the deactivation notification MO 520.

In some cases, if the measurement gap 505 overlaps with the on duration 510, then the UE may monitor for a WUS within the WUS MO 515. If the UE does not receive a WUS via the WUS MO 515, the UE may not monitor during the on duration 510. In this case, the UE may perform measurements in the measurement gap 505, as there may not be a conflict between the canceled on duration 510 and the measurement gap 505.

In some examples, the UE may receive a WUS via the WUS MO 515. The UE may monitor for a deactivation notification via a deactivation notification MO 520 during the on duration 510. The deactivation notification may indicate to cancel the measurement gap 505 (e.g., based on receiving the WUS. For example, prior to the offset 535, the UE may monitor for (e.g., and may receive) the deactivation notification via a deactivation notification MO 520). The deactivation MO 520 may occur at least the offset 535 (e.g., mg-offset) prior to the measurement gap 505. That is, the network entity may determine to cancel some or all of the measurement gap 505. The network entity may ensure that transmission of the deactivation notification occurs at least the offset 535 prior to the measurement gap 505. The network entity may schedule or select resources for transmission of the deactivation notification (e.g., the deactivation notification MO) to satisfy one or more timing constraints (e.g., to satisfy the offset 535), which may be defined by one or more rules or in one or more standards. In some examples, to successfully deactivate the measurement gap, the network entity may also ensure that the WUS is transmitted (e.g., via the WUS MO 515) to satisfy one or more timing constraints (e.g., the offset 525, the gap 530, or both) prior to the on duration, to ensure that the UE is awake during the on duration to receive the deactivation notification MO. Such timing constraints may be defined in one or more rules or in one or more standards documents.

In some implementations, the UE may receive a deactivation notification via the deactivation notification MO 520. The UE may cancel or deactivate the measurement gap 505 based on receiving the deactivation notification. The UE may monitor during the whole on duration 510 (e.g., the on duration 510 may be valid) based on cancelling the measurement gap. In other implementations, the UE may not receive a deactivation notification via the deactivation notification MO 520. In some cases, the UE may cancel or refrain from monitoring during the on duration 510 based on not receiving the deactivation notification. That is, the UE may assume the measurement gap 505 has priority (e.g., a higher priority) over the on duration 510. In some cases, the UE may assume the on duration is shortened or truncated based on the overlap and based on not receiving the deactivation notification. For example, the UE may monitor the on duration 510 until the tuning procedure for the measurement gap 505. That is, the on duration 510 may be truncated prior to or at the offset 535 (e.g., mg_offset) for the measurement gap 505. The UE may wake up during (e.g., perform monitoring, reception, or transmission) during a first portion of the on duration 510, and may then tune to the desired frequency (e.g., radio frequency) to perform the measurements in the measurement gap 505 during or after the offset 535, and may perform measurements during the measurement gap 505. In such cases, the network entity may schedule transmissions (e.g., uplink or downlink) during the on duration 510 according to one or more rules (e.g., may not perform transmissions or trigger uplink transmissions during a second portion of the on duration that overlaps with the measurement gap 505, the offset 535, or both).

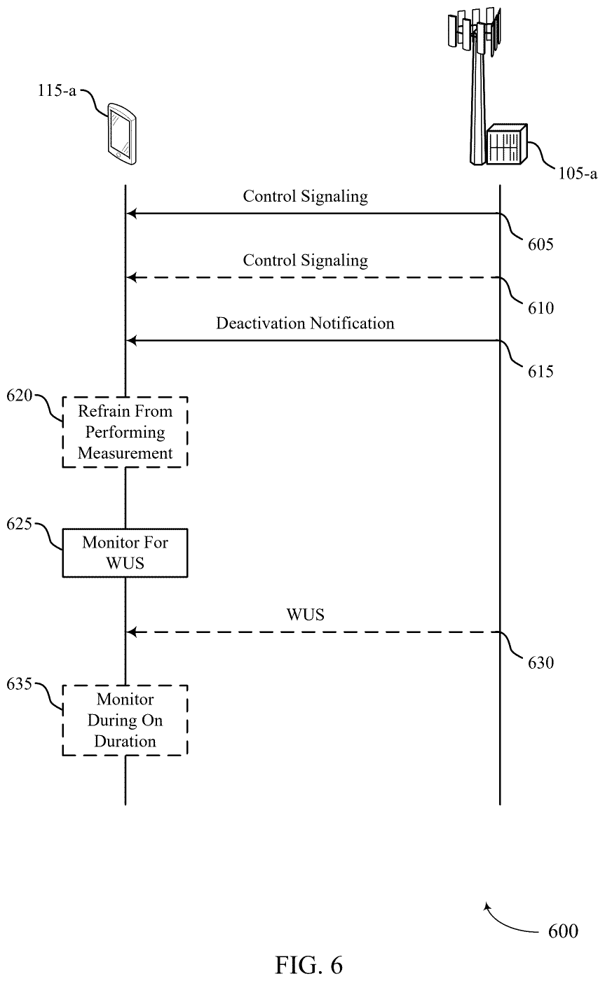

FIG. 6 shows an example of a process flow 600 that supports measurement gap deactivation timing in accordance with one or more aspects of the present disclosure. The process flow 600 may implement or be implemented to realize aspects of the wireless communications systems 100 or timing diagrams 200, 300, 400, or 500. For example, the process flow 600 illustrates communication between a UE 115-a and a network entity 105-a, which may be examples of corresponding devices described herein, including with reference to FIG. 1 through FIG. 5. The process flow 600 may provide for measurement gap deactivation timing procedures at a UE 115-a in the case that a measurement gap may overlap with a WUS MO.

At 605, the UE 115-a may receive, from the network entity 105-a, control signaling indicating multiple on durations and multiple off durations of a DRX cycle. The DRX cycle may be described further with respect to FIGS. 2, 4, and 5.

In some implementations, at 610, the UE 115-a may receive, from the network entity 105-a, control signaling (e.g., second control signaling) indicating a configuration of one or more measurement gaps. The configuration of the one or more measurement gaps may be described further with respect to FIGS. 3-5.

At 615, the UE 115-a may receive, from the network entity 105-a, a deactivation notification during a first MO during an on duration of the multiple on durations, where the deactivation notification indicates to deactivate a measurement gap based on the measurement gap overlapping with a second MO, and where a first time offset between the reception of the deactivation notification and the measurement gap satisfies a threshold measurement gap offset value. In some cases, the threshold measurement gap offset value is associated with an amount of time for the UE to tune to a frequency at which to perform one or more measurements during the measurement gap. In some cases, the network entity 105-a may determine when to transmit the deactivation notification based on the threshold measurement gap offset value and the first MO occurring during the on duration, as well as the measurement gap overlapping with the second MO.

In some implementations, at 620, the UE 115-a may refrain from performing measurements associated with neighboring cells in the measurement gap based on deactivating the measurement gap, as described at 615.

At 625, the UE 115-a may monitor, based on the first time offset satisfying the threshold measurement gap offset value and based on deactivating the measurement gap according to the deactivation notification (as described at 615), for a WUS within the second MO. The WUS may indicate for the UE 115-a to wake up during a second on duration of the multiple on durations. A second time offset between the second MO and a second on duration of the multiple on durations may satisfy a threshold time gap value.

In some implementations, at 630, the UE 115-a may receive the WUS via the second MO in accordance with monitoring for the WUS, as described at 625. In some cases, the WUS may include or may be an LP-WUS or a DCI signal. In some cases, the network entity 105-a may determine when to transmit the WUS based on the threshold time gap value and deactivating the measurement gap.

In some implementations, at 635, the UE 115-a may monitor during the second on duration based on receiving the WUS, as described further at 630.

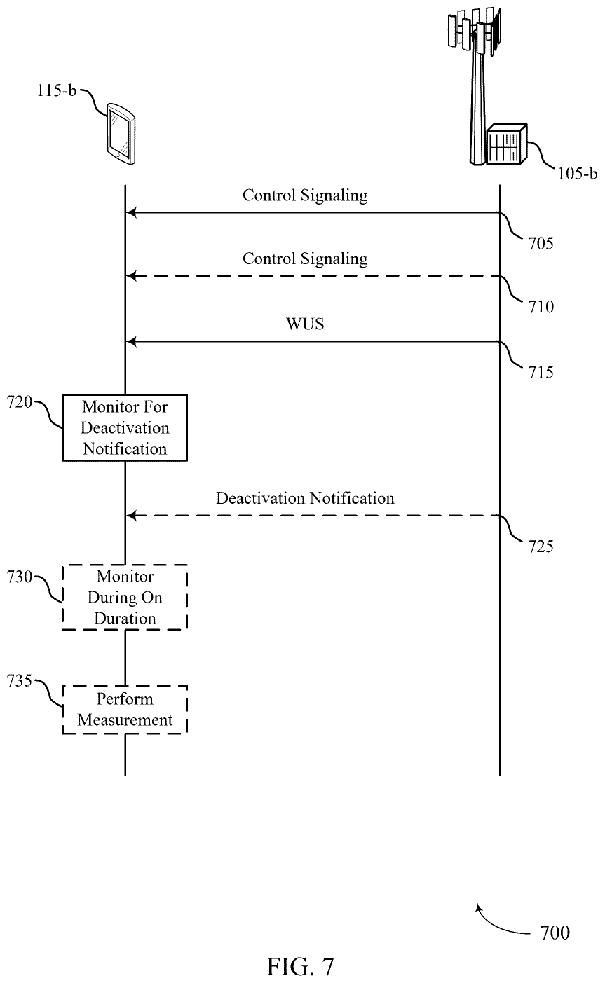

FIG. 7 shows an example of a process flow 700 that supports measurement gap deactivation timing in accordance with one or more aspects of the present disclosure. The process flow 700 may implement or be implemented to realize aspects of the wireless communications systems 100 or timing diagrams 200, 300, 400, or 500. For example, the process flow 700 illustrates communication between a UE 115-b and a network entity 105-b, which may be examples of corresponding devices described herein, including with reference to FIG. 1 through FIG. 5. The process flow 700 may provide for measurement gap deactivation timing procedures at a UE 115-a in the case that a measurement gap may overlap with a WUS MO.

At 705, the UE 115-b may receive, from the network entity 105-b, control signaling indicating multiple on durations and multiple off durations of a DRX cycle.

In some implementations, at 710, the UE 115-b may receive, from the network entity 105-b, control signaling (e.g., second control signaling) indicating a configuration of one or more measurement gaps.

At 715, the UE 115-b may receive the WUS during a first MO, the WUS indicating for the UE to monitor during an on duration of the multiple on durations, where the on duration may at least partially overlap with a measurement gap. That is, the WUS may indicate for the UE 115-a to wake up during an on duration (e.g., second on duration) of the multiple on durations. In some cases, one or more symbols of the on duration may overlap with one or more symbols of the measurement gap. In some examples, the UE 115-b may receive the WUS during the first MO based on a second time offset between the first MO and a second on duration of the multiple on durations satisfying a threshold time gap value. In some implementations, the WUS may be or may include an LP-WUS or a DCI signal. In some cases, the network entity 105-b may determine when to output the WUS based on the threshold time gap value and the on duration at least partially overlapping with the measurement gap.

At 720, the UE 115-b may monitor, during the on duration based on the WUS, for a deactivation notification within a second MO during the on duration, where the monitoring may be based on the on duration at least partially overlapping with the measurement gap as described further at 715, and where a time offset between the second MO and the measurement gap may satisfy a threshold measurement gap offset value. The deactivation notification may indicate for the UE 115-b to deactivate the measurement gap.

In some implementations, at 725, the UE 115-b may receive the deactivation notification via the second MO in accordance with monitoring for the deactivation notification, as described further at 720. In some cases, the network entity 105-a may determine when to output the deactivation notification based on the threshold measurement gap offset and receiving the WUS.

In some implementations, at 730, the UE 115-b may monitor, after the second MO, during the on duration in accordance with receiving the deactivation notification, as described further at 725. In some implementations, the UE 115-b may monitor, after the second MO, during a first portion of the on duration that does not overlap in time with the measurement gap based on failing to receive the deactivation notification via the second MO.

In some implementations, at 735, the UE 115-b may perform measurements during the measurement gap via one or more frequency resources, where the threshold measurement gap offset value may be associated with a threshold time duration for the UE to tune to the one or more frequency resources. In some cases, the UE 115-b may perform a measurement during at least a portion of the measurement gap that overlaps in time with the on duration based on failing to receive the deactivation notification via the second MO, the portion being different than the first portion of the on duration, as discussed at 730. In some examples, the UE 115-b may refrain, after the second MO, from monitoring during a remaining time duration of the on duration based at least in part on failing to receive the deactivation notification via the second MO. Based on refraining from monitoring during the on duration, the UE 115-b may perform one or more measurements during the measurement gap that at least partially overlaps with the on duration in accordance with failing to receive the deactivation notification via the second MO.

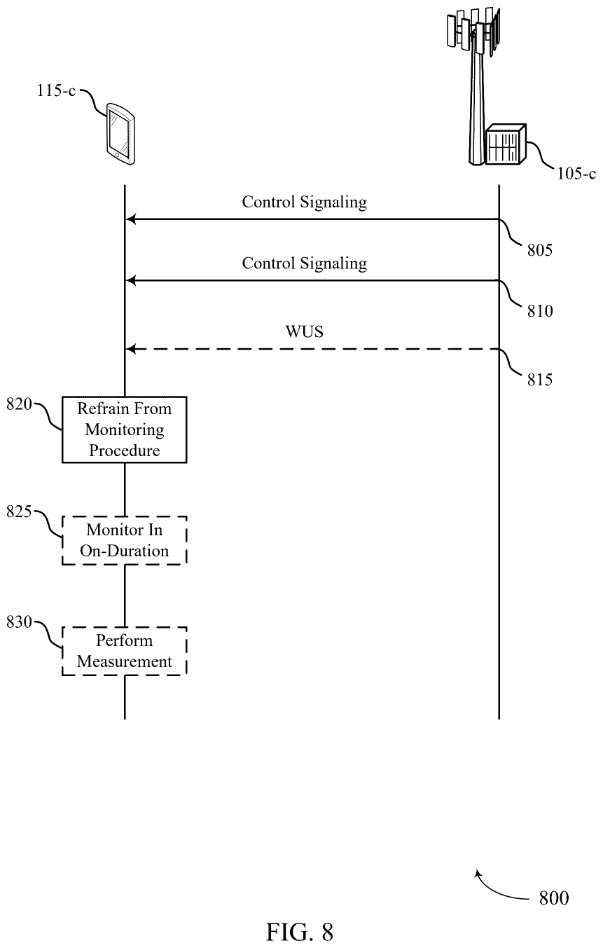

FIG. 8 shows an example of a process flow 800 that supports measurement gap deactivation timing in accordance with one or more aspects of the present disclosure. The process flow 800 may implement or be implemented to realize aspects of the wireless communications systems 100 or timing diagrams 200, 300, 400, or 500. For example, the process flow 800 illustrates communication between a UE 115-c and a network entity 105-c, which may be examples of corresponding devices described herein, including with reference to FIG. 1 through FIG. 5. The process flow 800 may provide for measurement gap deactivation timing procedures at a UE 115-c during conflict between measurement gaps, on durations, and WUS MOs.

At 805, the UE 115-c may receive, from the network entity 105-c, control signaling indicating multiple on durations and multiple off durations of a DRX cycle.

At 810, the UE 115-c may receive, from the network entity 105-c, control signaling (e.g., second control signaling) indicating a configuration of one or more measurement gaps.

In some implementations, at 815, the UE 115-c may receive a WUS, where the WUS may indicate an on duration of the plurality of on durations. That is, the WUS may indicate for the UE 115-c to monitor during an on duration of the multiple on durations. In some cases, the WUS may include or may be an LP-WUS or a DCI signal. In some cases, the network entity 105-c may determine when to output the WUS based on timing constraints associated with the DRX cycle and the configuration of the one or more measurement gaps.

At 820, The UE 115-c may refrain from performing a monitoring procedure via one or more MOs based on the DRX cycle and the configuration of the one or more measurement gaps satisfying one or more conditions. In some cases, the UE 115-c may refrain from monitoring for a deactivation notification within the one or more MOs based on the one or more conditions, where the one or more conditions include receiving the WUS, the WUS indicating an on duration of the multiple on durations as described at 815, where the on duration overlaps with a measurement gap of the one or more measurement gaps. In some cases, the UE 115-c may refrain from monitoring for a WUS within the one or more MOs based on the one or more conditions, where the one or more conditions include a measurement gap of the one or more measurement gaps at least partially overlapping with an on duration of the multiple on durations, the on duration associated with the WUS. In some cases, the UE 115-c may refrain from monitoring for a WUS within a MO of the one or more MOs based on the one or more conditions, where the one or more conditions includes a measurement gap of the one or more measurement gaps overlapping with the MO. In some implementations, the one or more conditions may be based on a first priority level associated with a measurement gap of the one or more measurement gaps, and a second priority level associated with an on duration of the multiple on durations.

In some implementations, at 825, The UE 115-c may monitor during the on duration in accordance with the WUS, as described at 815.

In some implementations, at 830, the UE 115-c may perform one or more measurements during the measurement gap based on refraining from monitoring for the WUS, as described at 820.

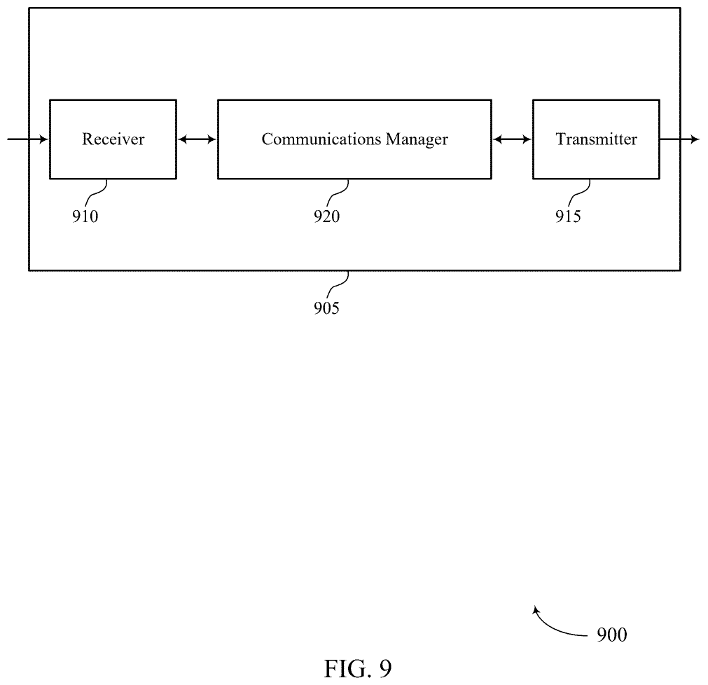

FIG. 9 shows a block diagram 900 of a device 905 that supports

measurement gap deactivation timing in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to measurement gap deactivation timing). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to measurement gap deactivation timing). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of measurement gap deactivation timing as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving control signaling indicating a set of multiple on durations and a set of multiple off durations of a discontinuous reception cycle. The communications manager 920 is capable of, configured to, or operable to support a means for receiving a deactivation notification during a first MO during a first on duration of the set of multiple on durations, where the deactivation notification indicates to deactivate a measurement gap based on the measurement gap overlapping with a second MO, and where a first time offset between reception of the deactivation notification and the measurement gap satisfies a threshold measurement gap offset value. The communications manager 920 is capable of, configured to, or operable to support a means for monitoring, based on the first time offset satisfying the threshold measurement gap offset value and deactivating the measurement gap according to the deactivation notification, for a WUS in the second MO, the WUS indicating for the UE to wake up during a second on duration of the set of multiple on durations, where a second time offset between the second MO and a second on duration of the set of multiple on durations satisfies a threshold time gap value.

Additionally, or alternatively, the communications manager 920 may support wireless communications in accordance with examples as disclosed herein. For example, the communications manager 920 is capable of, configured to, or operable to support a means for receiving control signaling indicating a set of multiple on durations and a set of multiple off durations associated with a discontinuous reception cycle. The communications manager 920 is capable of, configured to, or operable to support a means for receiving a WUS during a first MO, the WUS indicating for the UE to monitor during an on duration of the set of multiple on durations, where the on duration at least partially overlaps with a measurement gap. The communications manager 920 is capable of, configured to, or operable to support a means for monitoring, during the on duration based on the WUS, for a deactivation notification in a second MO during the on duration, where the monitoring is based on the on duration at least partially overlapping with the measurement gap, where the deactivation notification indicates to deactivate the measurement gap, and where a time offset between the second MO and the measurement gap satisfy a threshold measurement gap offset value.

Additionally, or alternatively, the communications manager 920 may support wireless communications in accordance with examples as disclosed herein. For example, the communications manager 920 is capable of, configured to, or operable to support a means for receiving control signaling indicating a set of multiple on durations and a set of multiple off durations associated with a discontinuous reception cycle. The communications manager 920 is capable of, configured to, or operable to support a means for receiving second control signaling indicating a configuration of one or more measurement gaps. The communications manager 920 is capable of, configured to, or operable to support a means for refraining from performing a monitoring procedure via one or more MOs based on the discontinuous reception cycle and the configuration of the one or more measurement gaps satisfying one or more conditions.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, reduced latency, and more efficient utilization of communication resources.

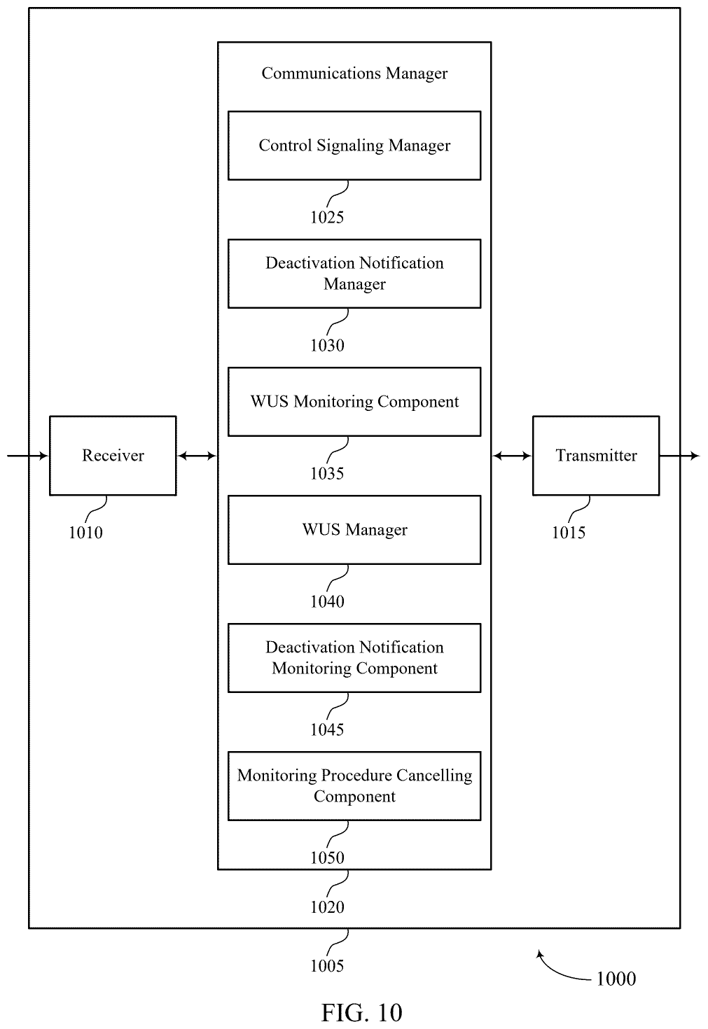

FIG. 10 shows a block diagram 1000 of a device 1005 that supports measurement gap deactivation timing in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to measurement gap deactivation timing). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to measurement gap deactivation timing). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of measurement gap deactivation timing as described herein. For example, the communications manager 1020 may include a control signaling manager 1025, a deactivation notification manager 1030, a WUS monitoring component 1035, a WUS manager 1040, a deactivation notification monitoring component 1045, a monitoring procedure cancelling component 1050, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The control signaling manager 1025 is capable of, configured to, or operable to support a means for receiving control signaling indicating a set of multiple on durations and a set of multiple off durations of a discontinuous reception cycle. The deactivation notification manager 1030 is capable of, configured to, or operable to support a means for receiving a deactivation notification during a first MO during a first on duration of the set of multiple on durations, where the deactivation notification indicates to deactivate a measurement gap based on the measurement gap overlapping with a second MO, and where a first time offset between reception of the deactivation notification and the measurement gap satisfies a threshold measurement gap offset value. The WUS monitoring component 1035 is capable of, configured to, or operable to support a means for monitoring, based on the first time offset satisfying the threshold measurement gap offset value and deactivating the measurement gap according to the deactivation notification, for a WUS in the second MO, the WUS indicating for the UE to wake up during a second on duration of the set of multiple on durations, where a second time offset between the second MO and a second on duration of the set of multiple on durations satisfies a threshold time gap value.

Additionally, or alternatively, the communications manager 1020 may support wireless communications in accordance with examples as disclosed herein. The control signaling manager 1025 is capable of, configured to, or operable to support a means for receiving control signaling indicating a set of multiple on durations and a set of multiple off durations associated with a discontinuous reception cycle. The WUS manager 1040 is capable of, configured to, or operable to support a means for receiving a WUS during a first MO, the WUS indicating for the UE to monitor during an on duration of the set of multiple on durations, where the on duration at least partially overlaps with a measurement gap. The deactivation notification monitoring component 1045 is capable of, configured to, or operable to support a means for monitoring, during the on duration based on the WUS, for a deactivation notification in a second MO during the on duration, where the monitoring is based on the on duration at least partially overlapping with the measurement gap, where the deactivation notification indicates to deactivate the measurement gap, and where a time offset between the second MO and the measurement gap satisfy a threshold measurement gap offset value.

Additionally, or alternatively, the communications manager 1020 may support wireless communications in accordance with examples as disclosed herein. The control signaling manager 1025 is capable of, configured to, or operable to support a means for receiving control signaling indicating a set of multiple on durations and a set of multiple off durations associated with a discontinuous reception cycle. The control signaling manager 1025 is capable of, configured to, or operable to support a means for receiving second control signaling indicating a configuration of one or more measurement gaps. The monitoring procedure cancelling component 1050 is capable of, configured to, or operable to support a means for refraining from performing a monitoring procedure via one or more MOs based on the discontinuous reception cycle and the configuration of the one or more measurement gaps satisfying one or more conditions.

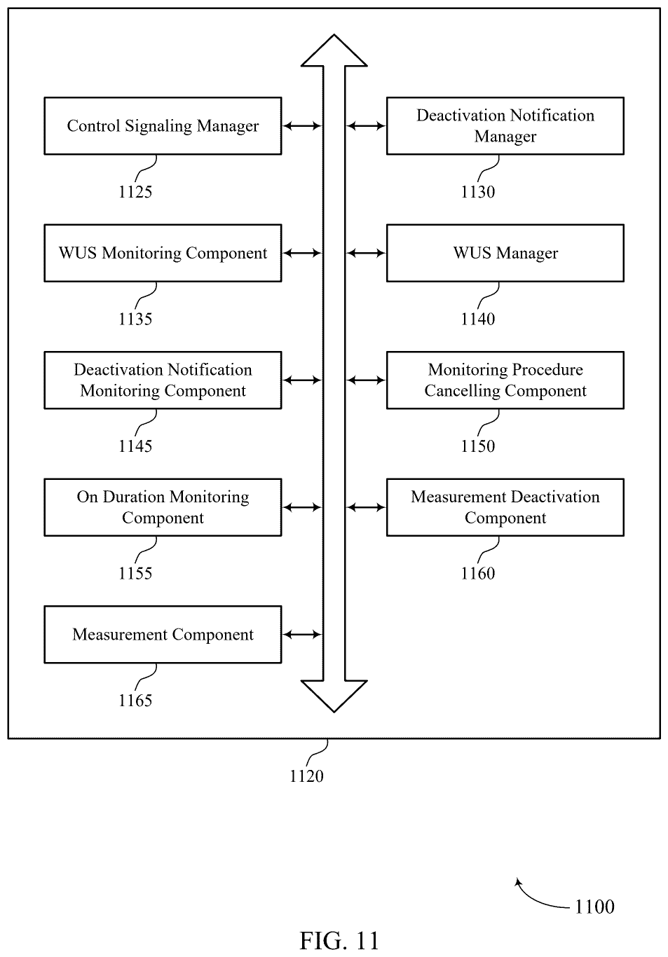

FIG. 11 shows a block diagram 1100 of a communications manager 1120 that supports measurement gap deactivation timing in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of measurement gap deactivation timing as described herein. For example, the communications manager 1120 may include a control signaling manager 1125, a deactivation notification manager 1130, a WUS monitoring component 1135, a WUS manager 1140, a deactivation notification monitoring component 1145, a monitoring procedure cancelling component 1150, an on duration monitoring component 1155, a measurement deactivation component 1160, a measurement component 1165, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The control signaling manager 1125 is capable of, configured to, or operable to support a means for receiving control signaling indicating a set of multiple on durations and a set of multiple off durations of a discontinuous reception cycle. The deactivation notification manager 1130 is capable of, configured to, or operable to support a means for receiving a deactivation notification during a first MO during a first on duration of the set of multiple on durations, where the deactivation notification indicates to deactivate a measurement gap based on the measurement gap overlapping with a second MO, and where a first time offset between reception of the deactivation notification and the measurement gap satisfies a threshold measurement gap offset value. The WUS monitoring component 1135 is capable of, configured to, or operable to support a means for monitoring, based on the first time offset satisfying the threshold measurement gap offset value and deactivating the measurement gap according to the deactivation notification, for a WUS in the second MO, the WUS indicating for the UE to wake up during a second on duration of the set of multiple on durations, where a second time offset between the second MO and a second on duration of the set of multiple on durations satisfies a threshold time gap value.

In some examples, the WUS manager 1140 is capable of, configured to, or operable to support a means for receiving the WUS in the second MO in accordance with monitoring for the WUS. In some examples, the on duration monitoring component 1155 is capable of, configured to, or operable to support a means for monitoring during the second on duration based on receiving the WUS.

In some examples, the measurement deactivation component 1160 is capable of, configured to, or operable to support a means for refraining from performing one or more measurements associated with neighboring cells in the measurement gap based on deactivating the measurement gap.

In some examples, the WUS includes an LP-WUS or a downlink control information signal.

In some examples, the threshold measurement gap offset value is associated with an amount of time for the UE to tune to a frequency at which to perform one or more measurements during the measurement gap.

Additionally, or alternatively, the communications manager 1120 may support wireless communications in accordance with examples as disclosed herein. In some examples, the control signaling manager 1125 is capable of, configured to, or operable to support a means for receiving control signaling indicating a set of multiple on durations and a set of multiple off durations associated with a discontinuous reception cycle. The WUS manager 1140 is capable of, configured to, or operable to support a means for receiving a WUS during a first MO, the WUS indicating for the UE to monitor during an on duration of the set of multiple on durations, where the on duration at least partially overlaps with a measurement gap. The deactivation notification monitoring component 1145 is capable of, configured to, or operable to support a means for monitoring, during the on duration based on the WUS, for a deactivation notification in a second MO during the on duration, where the monitoring is based on the on duration at least partially overlapping with the measurement gap, where the deactivation notification indicates to deactivate the measurement gap, and where a time offset between the second MO and the measurement gap satisfy a threshold measurement gap offset value.

In some examples, the deactivation notification manager 1130 is capable of, configured to, or operable to support a means for receiving the deactivation notification in the second MO in accordance with the monitoring. In some examples, the on duration monitoring component 1155 is capable of, configured to, or operable to support a means for monitoring, after the second MO, during the on duration in accordance with receiving the deactivation notification.

In some examples, the monitoring procedure cancelling component 1150 is capable of, configured to, or operable to support a means for refraining, after the second MO, from monitoring during a remaining time duration of the on duration based on failing to receive the deactivation notification in the second MO. In some examples, the measurement component 1165 is capable of, configured to, or operable to support a means for performing one or more measurements during the measurement gap that at least partially overlaps with the on duration in accordance with failing to receive the deactivation notification in the second MO and based on refraining from monitoring during the on duration.

In some examples, the on duration monitoring component 1155 is capable of, configured to, or operable to support a means for monitoring, after the second MO, during a first portion of the on duration that does not overlap in time with the measurement gap based on failing to receive the deactivation notification in the second MO. In some examples, the measurement component 1165 is capable of, configured to, or operable to support a means for performing a measurement during at least a portion of the measurement gap that overlaps in time with the on duration based on failing to receive the deactivation notification in the second MO.

In some examples, the measurement component 1165 is capable of, configured to, or operable to support a means for performing one or more measurements during the measurement gap via one or more frequency resources, where the threshold measurement gap offset value is associated with a threshold time duration for the UE to tune to the one or more frequency resources.

In some examples, one or more symbols of the on duration overlaps with one or more symbols of the measurement gap.

In some examples, receiving the WUS during the first MO is based on a second time offset between the first MO and a second on duration of the set of multiple on durations satisfying a threshold time gap value.

In some examples, the WUS includes an LP-WUS or a downlink control information signal.

Additionally, or alternatively, the communications manager 1120 may support wireless communications in accordance with examples as disclosed herein. In some examples, the control signaling manager 1125 is capable of, configured to, or operable to support a means for receiving control signaling indicating a set of multiple on durations and a set of multiple off durations associated with a discontinuous reception cycle. In some examples, the control signaling manager 1125 is capable of, configured to, or operable to support a means for receiving second control signaling indicating a configuration of one or more measurement gaps. The monitoring procedure cancelling component 1150 is capable of, configured to, or operable to support a means for refraining from performing a monitoring procedure via one or more MOs based on the discontinuous reception cycle and the configuration of the one or more measurement gaps satisfying one or more conditions.

In some examples, to support refraining from performing the monitoring procedure based on the discontinuous reception cycle and the configuration of the one or more measurement gaps satisfying the one or more conditions, the monitoring procedure cancelling component 1150 is capable of, configured to, or operable to support a means for refraining from monitoring for a deactivation notification in the one or more MOs based on the one or more conditions, where the one or more conditions includes receiving a WUS, the WUS indicating an on duration of the set of multiple on durations, where the on duration overlaps with a measurement gap of the one or more measurement gaps. In some examples, to support refraining from performing the monitoring procedure based on the discontinuous reception cycle and the configuration of the one or more measurement gaps satisfying the one or more conditions, the on duration monitoring component 1155 is capable of, configured to, or operable to support a means for monitoring during the on duration in accordance with the WUS.

In some examples, the WUS includes an LP-WUS or a downlink control information signal.

In some examples, to support refraining from performing the monitoring procedure based on the discontinuous reception cycle and the configuration of the one or more measurement gaps satisfying the one or more conditions, the monitoring procedure cancelling component 1150 is capable of, configured to, or operable to support a means for refraining from monitoring for a WUS in the one or more MOs based on the one or more conditions, where the one or more conditions includes a measurement gap of the one or more measurement gaps at least partially overlapping with an on duration of the set of multiple on durations, the on duration associated with the WUS. In some examples, to support refraining from performing the monitoring procedure based on the discontinuous reception cycle and the configuration of the one or more measurement gaps satisfying the one or more conditions, the measurement component 1165 is capable of, configured to, or operable to support a means for performing one or more measurements during the measurement gap based on refraining from monitoring for the WUS.

In some examples, to support refraining from performing the monitoring procedure based on the discontinuous reception cycle and the configuration of the one or more measurement gaps satisfying the one or more conditions, the monitoring procedure cancelling component 1150 is capable of, configured to, or operable to support a means for refraining from monitoring for a WUS in a MO of the one or more MOs based on the one or more conditions, where the one or more conditions includes a measurement gap of the one or more measurement gaps overlapping with the MO. In some examples, to support refraining from performing the monitoring procedure based on the discontinuous reception cycle and the configuration of the one or more measurement gaps satisfying the one or more conditions, the measurement component 1165 is capable of, configured to, or operable to support a means for performing one or more measurements during the measurement gap based on refraining from monitoring for the WUS.

In some examples, the WUS includes an LP-WUS or a downlink control information signal.

In some examples, the one or more conditions are based on a first priority level associated with a measurement gap of the one or more measurement gaps, and a second priority level associated with an on duration of the set of multiple on durations.

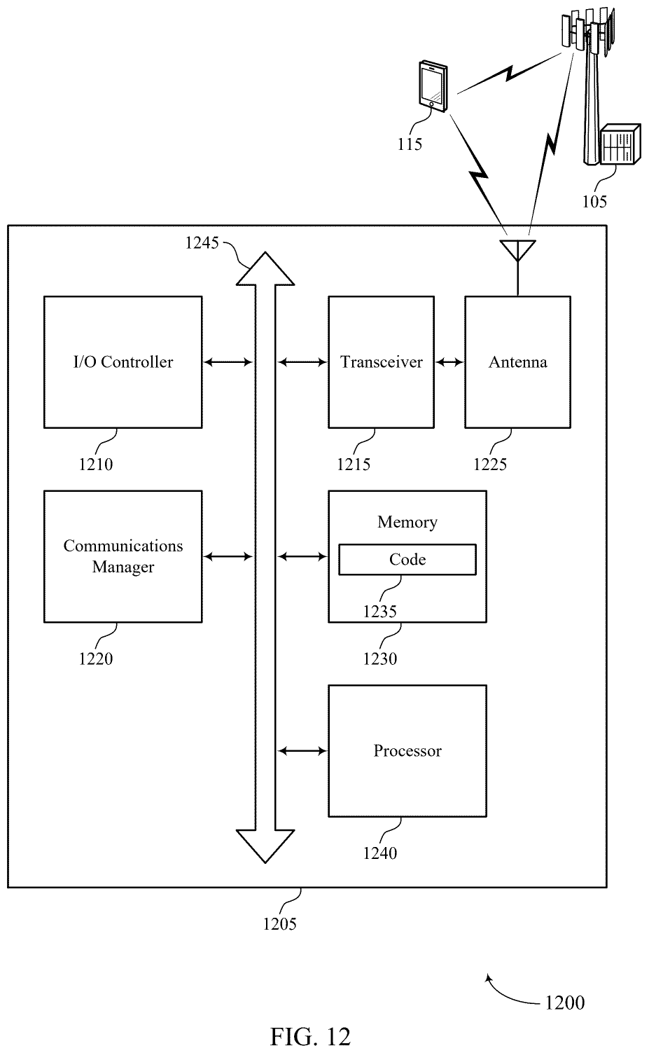

FIG. 12 shows a diagram of a system 1200 including a device 1205 that supports measurement gap deactivation timing in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®,UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting measurement gap deactivation timing). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving control signaling indicating a set of multiple on durations and a set of multiple off durations of a discontinuous reception cycle. The communications manager 1220 is capable of, configured to, or operable to support a means for receiving a deactivation notification during a first MO during a first on duration of the set of multiple on durations, where the deactivation notification indicates to deactivate a measurement gap based on the measurement gap overlapping with a second MO, and where a first time offset between reception of the deactivation notification and the measurement gap satisfies a threshold measurement gap offset value. The communications manager 1220 is capable of, configured to, or operable to support a means for monitoring, based on the first time offset satisfying the threshold measurement gap offset value and deactivating the measurement gap according to the deactivation notification, for a WUS in the second MO, the WUS indicating for the UE to wake up during a second on duration of the set of multiple on durations, where a second time offset between the second MO and a second on duration of the set of multiple on durations satisfies a threshold time gap value.

Additionally, or alternatively, the communications manager 1220 may support wireless communications in accordance with examples as disclosed herein. For example, the communications manager 1220 is capable of, configured to, or operable to support a means for receiving control signaling indicating a set of multiple on durations and a set of multiple off durations associated with a discontinuous reception cycle. The communications manager 1220 is capable of, configured to, or operable to support a means for receiving a WUS during a first MO, the WUS indicating for the UE to monitor during an on duration of the set of multiple on durations, where the on duration at least partially overlaps with a measurement gap. The communications manager 1220 is capable of, configured to, or operable to support a means for monitoring, during the on duration based on the WUS, for a deactivation notification in a second MO during the on duration, where the monitoring is based on the on duration at least partially overlapping with the measurement gap, where the deactivation notification indicates to deactivate the measurement gap, and where a time offset between the second MO and the measurement gap satisfy a threshold measurement gap offset value.

Additionally, or alternatively, the communications manager 1220 may support wireless communications in accordance with examples as disclosed herein. For example, the communications manager 1220 is capable of, configured to, or operable to support a means for receiving control signaling indicating a set of multiple on durations and a set of multiple off durations associated with a discontinuous reception cycle. The communications manager 1220 is capable of, configured to, or operable to support a means for receiving second control signaling indicating a configuration of one or more measurement gaps. The communications manager 1220 is capable of, configured to, or operable to support a means for refraining from performing a monitoring procedure via one or more MOs based on the discontinuous reception cycle and the configuration of the one or more measurement gaps satisfying one or more conditions.

By including or configuring the communications manager 1220 in accordance with examples as described herein, the device 1205 may support techniques for improved communication reliability, improved user experience related to reduced processing, reduced power consumption, reduced latency, and more efficient utilization of processing and measurement capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of measurement gap deactivation timing as described herein, or the at least one processor 1240 and the at least one memory 1230 may be otherwise configured to, individually or collectively, perform or support such operations.

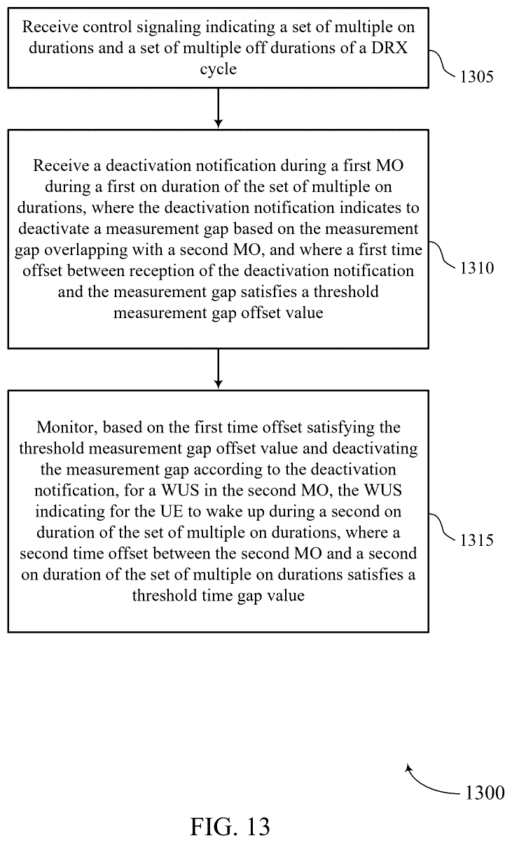

FIG. 13 shows a flowchart illustrating a method 1300 that supports measurement gap deactivation timing in accordance with one or more aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicating a set of multiple on durations and a set of multiple off durations of a discontinuous reception cycle. The operations of 1305 may be performed in accordance with examples as disclosed herein. In some examples, aspects of the operations of 1305 may be performed by a control signaling manager 1125 as described with reference to FIG. 11.

At 1310, the method may include receiving a deactivation notification during a first MO during a first on duration of the set of multiple on durations, where the deactivation notification indicates to deactivate a measurement gap based on the measurement gap overlapping with a second MO, and where a first time offset between reception of the deactivation notification and the measurement gap satisfies a threshold measurement gap offset value. The operations of 1310 may be performed in accordance with examples as disclosed herein. In some examples, aspects of the operations of 1310 may be performed by a deactivation notification manager 1130 as described with reference to FIG. 11.

At 1315, the method may include monitoring, based on the first time offset satisfying the threshold measurement gap offset value and deactivating the measurement gap according to the deactivation notification, for a WUS in the second MO, the WUS indicating for the UE to wake up during a second on duration of the set of multiple on durations, where a second time offset between the second MO and a second on duration of the set of multiple on durations satisfies a threshold time gap value. The operations of 1315 may be performed in accordance with examples as disclosed herein. In some examples, aspects of the operations of 1315 may be performed by a WUS monitoring component 1135 as described with reference to FIG. 11.

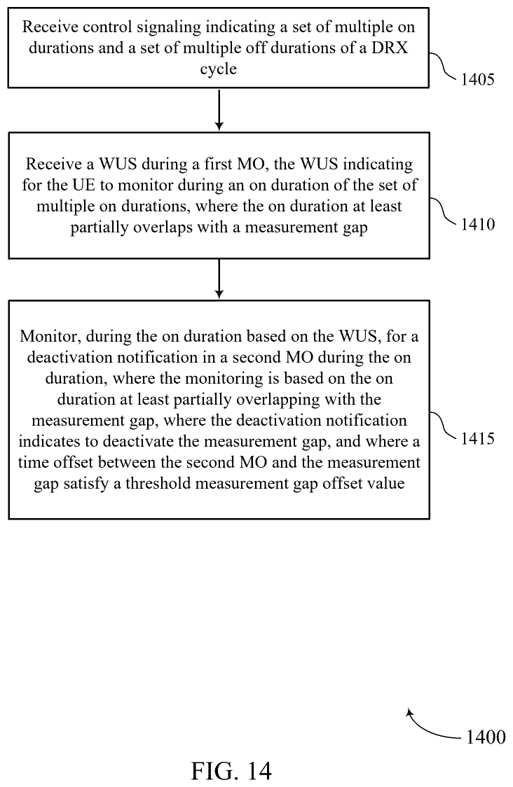

FIG. 14 shows a flowchart illustrating a method 1400 that supports measurement gap deactivation timing in accordance with one or more aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include receiving control signaling indicating a set of multiple on durations and a set of multiple off durations associated with a discontinuous reception cycle. The operations of 1405 may be performed in accordance with examples as disclosed herein. In some examples, aspects of the operations of 1405 may be performed by a control signaling manager 1125 as described with reference to FIG. 11.

At 1410, the method may include receiving a WUS during a first MO, the WUS indicating for the UE to monitor during an on duration of the set of multiple on durations, where the on duration at least partially overlaps with a measurement gap. The operations of 1410 may be performed in accordance with examples as disclosed herein. In some examples, aspects of the operations of 1410 may be performed by a WUS manager 1140 as described with reference to FIG. 11.

At 1415, the method may include monitoring, during the on duration based on the WUS, for a deactivation notification in a second MO during the on duration, where the monitoring is based on the on duration at least partially overlapping with the measurement gap, where the deactivation notification indicates to deactivate the measurement gap, and where a time offset between the second MO and the measurement gap satisfy a threshold measurement gap offset value. The operations of 1415 may be performed in accordance with examples as disclosed herein. In some examples, aspects of the operations of 1415 may be performed by a deactivation notification monitoring component 1145 as described with reference to FIG. 11.

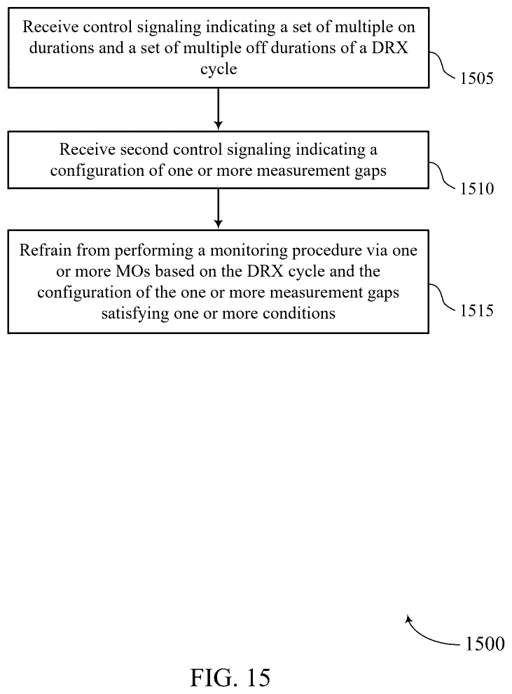

FIG. 15 shows a flowchart illustrating a method 1500 that supports measurement gap deactivation timing in accordance with one or more aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1505, the method may include receiving control signaling indicating a set of multiple on durations and a set of multiple off durations associated with a discontinuous reception cycle. The operations of 1505 may be performed in accordance with examples as disclosed herein. In some examples, aspects of the operations of 1505 may be performed by a control signaling manager 1125 as described with reference to FIG. 11.

At 1510, the method may include receiving second control signaling indicating a configuration of one or more measurement gaps. The operations of 1510 may be performed in accordance with examples as disclosed herein. In some examples, aspects of the operations of 1510 may be performed by a control signaling manager 1125 as described with reference to FIG. 11.

At 1515, the method may include refraining from performing a monitoring procedure via one or more MOs based on the discontinuous reception cycle and the configuration of the one or more measurement gaps satisfying one or more conditions. The operations of 1515 may be performed in accordance with examples as disclosed herein. In some examples, aspects of the operations of 1515 may be performed by a monitoring procedure cancelling component 1150 as described with reference to FIG. 11.

The following provides an overview of aspects of the present disclosure:

Aspect 1: A method for wireless communications at a UE, comprising: receiving control signaling indicating a plurality of on durations and a plurality of off durations of a DRX cycle; receiving a deactivation notification during a first MO during a first on duration of the plurality of on durations, wherein the deactivation notification indicates to deactivate a measurement gap based at least in part on the measurement gap overlapping with a second MO, and wherein a first time offset between reception of the deactivation notification and the measurement gap satisfies a threshold measurement gap offset value; and monitoring, based at least in part on the first time offset satisfying the threshold measurement gap offset value and deactivating the measurement gap according to the deactivation notification, for a WUS in the second MO, the WUS indicating for the UE to wake up during a second on duration of the plurality of on durations, wherein a second time offset between the second MO and a second on duration of the plurality of on durations satisfies a threshold time gap value.

Aspect 2: The method of aspect 1, further comprising: receiving the WUS in the second MO in accordance with monitoring for the WUS; and monitoring during the second on duration based on receiving the WUS.

Aspect 3: The method of any of aspects 1 through 2, further comprising: refraining from performing one or more measurements associated with neighboring cells in the measurement gap based at least in part on deactivating the measurement gap.

Aspect 4: The method of any of aspects 1 through 3, wherein the WUS comprises an LP-WUS or a DCI signal.

Aspect 5: The method of any of aspects 1 through 4, wherein the threshold measurement gap offset value is associated with an amount of time for the UE to tune to a frequency at which to perform one or more measurements during the measurement gap

Aspect 6: A method for wireless communications at a UE, comprising: receiving control signaling indicating a plurality of on durations and a plurality of off durations associated with a DRX cycle; receiving a WUS during a first MO, the WUS indicating for the UE to monitor during an on duration of the plurality of on durations, wherein the on duration at least partially overlaps with a measurement gap; and monitoring, during the on duration based at least in part on the WUS, for a deactivation notification in a second MO during the on duration, wherein the monitoring is based at least in part on the on duration at least partially overlapping with the measurement gap, wherein the deactivation notification indicates to deactivate the measurement gap, and wherein a time offset between the second MO and the measurement gap satisfy a threshold measurement gap offset value.

Aspect 7: The method of aspect 6, further comprising: receiving the deactivation notification in the second MO in accordance with the monitoring; and monitoring, after the second MO, during the on duration in accordance with receiving the deactivation notification.

Aspect 8: The method of any of aspects 6 through 7, further comprising: refraining, after the second MO, from monitoring during a remaining time duration of the on duration based at least in part on failing to receive the deactivation notification in the second MO; and performing one or more measurements during the measurement gap that at least partially overlaps with the on duration in accordance with failing to receive the deactivation notification in the second MO and based at least in part on refraining from monitoring during the on duration.

Aspect 9: The method of any of aspects 6 through 8, further comprising: monitoring, after the second MO, during a first portion of the on duration that does not overlap in time with the measurement gap based at least in part on failing to receive the deactivation notification in the second MO; and performing a measurement during at least a portion of the measurement gap that overlaps in time with the on duration based at least in part on failing to receive the deactivation notification in the second MO.

Aspect 10: The method of any of aspects 6 through 9, further comprising: performing one or more measurements during the measurement gap via one or more frequency resources, wherein the threshold measurement gap offset value is associated with a threshold time duration for the UE to tune to the one or more frequency resources.

Aspect 11: The method of any of aspects 6 through 10, wherein one or more symbols of the on duration overlaps with one or more symbols of the measurement gap.

Aspect 12: The method of any of aspects 6 through 11, wherein receiving the WUS during the first MO is based at least in part on a second time offset between the first MO and a second on duration of the plurality of on durations satisfying a threshold time gap value.

Aspect 13: The method of any of aspects 6 through 12, wherein the WUS comprises an LP-WUS or a DCI signal.

Aspect 14: A method for wireless communications at a UE, comprising: receiving control signaling indicating a plurality of on durations and a plurality of off durations associated with a DRX cycle; receiving second control signaling indicating a configuration of one or more measurement gaps; and refraining from performing a monitoring procedure via one or more MOs based at least in part on the DRX cycle and the configuration of the one or more measurement gaps satisfying one or more conditions.

Aspect 15: The method of aspect 14, wherein refraining from performing the monitoring procedure based at least in part on the DRX cycle and the configuration of the one or more measurement gaps satisfying the one or more conditions comprises: refraining from monitoring for a deactivation notification in the one or more MOs based at least in part on the one or more conditions, wherein the one or more conditions comprises receiving a WUS, the WUS indicating an on duration of the plurality of on durations, wherein the on duration overlaps with a measurement gap of the one or more measurement gaps; and monitoring during the on duration in accordance with the WUS.

Aspect 16: The method of aspect 15, wherein the WUS comprises an LP-WUS or a DCI signal.

Aspect 17: The method of any of aspects 14 through 16, wherein refraining from performing the monitoring procedure based at least in part on the DRX cycle and the configuration of the one or more measurement gaps satisfying the one or more conditions comprises: refraining from monitoring for a WUS in the one or more MOs based at least in part on the one or more conditions, wherein the one or more conditions comprises a measurement gap of the one or more measurement gaps at least partially overlapping with an on duration of the plurality of on durations, the on duration associated with the WUS; and performing one or more measurements during the measurement gap based at least in part on refraining from monitoring for the WUS.

Aspect 18: The method of any of aspects 14 through 17, wherein refraining from performing the monitoring procedure based at least in part on the DRX cycle and the configuration of the one or more measurement gaps satisfying the one or more conditions comprises: refraining from monitoring for a WUS in a MO of the one or more MOs based at least in part on the one or more conditions, wherein the one or more conditions comprises a measurement gap of the one or more measurement gaps overlapping with the MO; and performing one or more measurements during the measurement gap based at least in part on refraining from monitoring for the WUS.

Aspect 19: The method of aspect 18, wherein the WUS comprises an LP-WUS or a DCI signal.

Aspect 20: The method of any of aspects 14 through 19, wherein the one or more conditions are based at least in part on a first priority level associated with a measurement gap of the one or more measurement gaps, and a second priority level associated with an on duration of the plurality of on durations.

Aspect 21: A UE for wireless communications, comprising one or more memories storing processor-executable code, and one or more processors coupled with the one or more memories and individually or collectively operable to execute the code to cause the UE to perform a method of any of aspects 1 through 5.

Aspect 22: A UE for wireless communications, comprising at least one means for performing a method of any of aspects 1 through 5.

Aspect 23: A non-transitory computer-readable medium storing code for wireless communications, the code comprising instructions executable by one or more processors to perform a method of any of aspects 1 through 5.

Aspect 24: A UE for wireless communications, comprising one or more memories storing processor-executable code, and one or more processors coupled with the one or more memories and individually or collectively operable to execute the code to cause the UE to perform a method of any of aspects 6 through 13.

Aspect 25: A UE for wireless communications, comprising at least one means for performing a method of any of aspects 6 through 13.

Aspect 26: A non-transitory computer-readable medium storing code for wireless communications, the code comprising instructions executable by one or more processors to perform a method of any of aspects 6 through 13.

Aspect 27: A UE for wireless communications, comprising one or more memories storing processor-executable code, and one or more processors coupled with the one or more memories and individually or collectively operable to execute the code to cause the UE to perform a method of any of aspects 14 through 20.

Aspect 28: A UE for wireless communications, comprising at least one means for performing a method of any of aspects 14 through 20.

Aspect 29: A non-transitory computer-readable medium storing code for wireless communications, the code comprising instructions executable by one or more processors to perform a method of any of aspects 14 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating a plurality of on durations and a plurality of off durations of a discontinuous reception cycle;
receive a deactivation notification during a first monitoring occasion during a first on duration of the plurality of on durations, wherein the deactivation notification indicates to deactivate a measurement gap based at least in part on the measurement gap overlapping with a second monitoring occasion, and wherein a first time offset between reception of the deactivation notification and the measurement gap satisfies a threshold measurement gap offset value; and
monitor, based at least in part on the first time offset satisfying the threshold measurement gap offset value and deactivating the measurement gap according to the deactivation notification, for a wake-up signal in the second monitoring occasion, the wake-up signal indicating for the UE to wake up during a second on duration of the plurality of on durations, wherein a second time offset between the second monitoring occasion and a second on duration of the plurality of on durations satisfies a threshold time gap value.

2. The UE of claim 1, wherein the one or more processors are individually or collectively further operable to execute the code to cause the UE to:
receive the wake-up signal in the second monitoring occasion in accordance with monitoring for the wake-up signal; and
monitor during the second on duration based on receiving the wake-up signal.

3. The UE of claim 1, wherein the one or more processors are individually or collectively further operable to execute the code to cause the UE to:
refrain from performing one or more measurements associated with neighboring cells in the measurement gap based at least in part on deactivating the measurement gap.

4. The UE of claim 1, wherein the wake-up signal comprises a low-power wake-up signal or a downlink control information signal.

5. The UE of claim 1, wherein the threshold measurement gap offset value is associated with an amount of time for the UE to tune to a frequency at which to perform one or more measurements during the measurement gap.

6. A user equipment (UE), comprising:
one or more memories storing processor-executable code; and
one or more processors coupled with the one or more memories and individually or collectively operable to execute the code to cause the UE to:
receive control signaling indicating a plurality of on durations and a plurality of off durations associated with a discontinuous reception cycle;
receive a wake-up signal during a first monitoring occasion, the wake-up signal indicating for the UE to monitor during an on duration of the plurality of on durations, wherein the on duration at least partially overlaps with a measurement gap; and
monitor, during the on duration based at least in part on the wake-up signal, for a deactivation notification in a second monitoring occasion during the on duration, wherein the monitoring is based at least in part on the on duration at least partially overlapping with the measurement gap, wherein the deactivation notification indicates to deactivate the measurement gap, and wherein a time offset between the second monitoring occasion and the measurement gap satisfy a threshold measurement gap offset value.

7. The UE of claim 6, wherein the one or more processors are individually or collectively further operable to execute the code to cause the UE to:
receive the deactivation notification in the second monitoring occasion in accordance with the monitoring; and
monitor, after the second monitoring occasion, during the on duration in accordance with receiving the deactivation notification.

8. The UE of claim 6, wherein the one or more processors are individually or collectively further operable to execute the code to cause the UE to:
refrain, after the second monitoring occasion, from monitoring during a remaining time duration of the on duration based at least in part on failing to receive the deactivation notification in the second monitoring occasion; and
perform one or more measurements during the measurement gap that at least partially overlaps with the on duration in accordance with failing to receive the deactivation notification in the second monitoring occasion and based at least in part on refraining from monitoring during the on duration.

9. The UE of claim 6, wherein the one or more processors are individually or collectively further operable to execute the code to cause the UE to:
monitor, after the second monitoring occasion, during a first portion of the on duration that does not overlap in time with the measurement gap based at least in part on failing to receive the deactivation notification in the second monitoring occasion; and
perform a measurement during at least a portion of the measurement gap that overlaps in time with the on duration based at least in part on failing to receive the deactivation notification in the second monitoring occasion.

10. The UE of claim 6, wherein the one or more processors are individually or collectively further operable to execute the code to cause the UE to:
perform one or more measurements during the measurement gap via one or more frequency resources, wherein the threshold measurement gap offset value is associated with a threshold time duration for the UE to tune to the one or more frequency resources.

11. The UE of claim 6, wherein one or more symbols of the on duration overlaps with one or more symbols of the measurement gap.

12. The UE of claim 6, wherein receiving the wake-up signal during the first monitoring occasion is based at least in part on a second time offset between the first monitoring occasion and a second on duration of the plurality of on durations satisfying a threshold time gap value.

13. The UE of claim 6, wherein the wake-up signal comprises a low-power wake-up signal or a downlink control information signal.

14. A user equipment (UE), comprising:
one or more memories storing processor-executable code; and
one or more processors coupled with the one or more memories and individually or collectively operable to execute the code to cause the UE to:
receive control signaling indicating a plurality of on durations and a plurality of off durations associated with a discontinuous reception cycle;
receive second control signaling indicating a configuration of one or more measurement gaps; and
refrain from performing a monitoring procedure via one or more monitoring occasions based at least in part on the discontinuous reception cycle and the configuration of the one or more measurement gaps satisfying one or more conditions.

15. The UE of claim 14, wherein, to refrain from performing the monitoring procedure based at least in part on the discontinuous reception cycle and the configuration of the one or more measurement gaps satisfying the one or more conditions, the one or more processors are individually or collectively operable to execute the code to cause the UE to:
refrain from monitoring for a deactivation notification in the one or more monitoring occasions based at least in part on the one or more conditions, wherein the one or more conditions comprises receiving a wake-up signal, the wake-up signal indicating an on duration of the plurality of on durations, wherein the on duration overlaps with a measurement gap of the one or more measurement gaps; and
monitor during the on duration in accordance with the wake-up signal.

16. The UE of claim 15, wherein the wake-up signal comprises a low-power wake-up signal or a downlink control information signal.

17. The UE of claim 14, wherein, to refrain from performing the monitoring procedure based at least in part on the discontinuous reception cycle and the configuration of the one or more measurement gaps satisfying the one or more conditions, the one or more processors are individually or collectively operable to execute the code to cause the UE to:
refrain from monitoring for a wake-up signal in the one or more monitoring occasions based at least in part on the one or more conditions, wherein the one or more conditions comprises a measurement gap of the one or more measurement gaps at least partially overlapping with an on duration of the plurality of on durations, the on duration associated with the wake-up signal; and
perform one or more measurements during the measurement gap based at least in part on refraining from monitoring for the wake-up signal.

18. The UE of claim 14, wherein, to refrain from performing the monitoring procedure based at least in part on the discontinuous reception cycle and the configuration of the one or more measurement gaps satisfying the one or more conditions, the one or more processors are individually or collectively operable to execute the code to cause the UE to:
refrain from monitoring for a wake-up signal in a monitoring occasion of the one or more monitoring occasions based at least in part on the one or more conditions, wherein the one or more conditions comprises a measurement gap of the one or more measurement gaps overlapping with the monitoring occasion; and
perform one or more measurements during the measurement gap based at least in part on refraining from monitoring for the wake-up signal.

19. The UE of claim 18, wherein the wake-up signal comprises a low-power wake-up signal or a downlink control information signal.

20. The UE of claim 14, wherein the one or more conditions are based at least in part on a first priority level associated with a measurement gap of the one or more measurement gaps, and a second priority level associated with an on duration of the plurality of on durations.
